(19) United States
(12) Patent Application Publication
(10) Pub. No.: US 2016/0026226 A1
(43) Pub. Date: Jan. 28, 2016

(54) Method and Apparatus to Search Data and Notify and Update a User

(71) Applicant: Larry Maurice Deutsch, Cupertino, CA (US)

(72) Inventor: Larry Maurice Deutsch, Cupertino, CA (US)

(21) Appl. No.: 14/873,206

(22) Filed: Oct. 2, 2015

Related U.S. Application Data
(63) Continuation-in-part of application No. 14/079,647, filed on Nov. 14, 2013.
Application No. 14/079,647 is a continuation of application No. 13/373,600, filed on Nov. 21, 2011, now Pat. No. 8,589,376.
(60) Provisional application No. 61/458,442, filed on Nov. 23, 2010.

(51) Int. Cl. G06F 1/26

(52) U.S. Cl. CPC G06F 1/26

(57) ABSTRACT

The present invention allows a user to subscribe to multiple concurrent channels of syndicated content published over the internet. The user receives notification of the content which is new since the previous time that the user accessed a channel. In one embodiment, the user can select the frequency of checking for new content. In another embodiment, the system or user can select among network access profiles that balances the tradeoff between battery usage and user responsiveness. In addition, the user can specify a maximum number of changes to be presented and the user can specify how far back in time to check.

### CROSS REFERENCE TO RELATED APPLICATIONS

This application is a continuation-in-part of U.S. patent application Ser. No. 14/079,647 filed Nov. 14, 2013 by Larry Deutsch the entire file wrapper contents of which are hereby incorporated by reference as though fully set out at length. In turn, U.S. patent application Ser. No. 14/079,647 claimed the benefit of U.S. patent application Ser. No. 13/373,600. In turn, U.S. patent application Ser. No. 13/373,600 claimed the benefit under 35 USC 119(e) of U.S. Provisional Application No. 61/458,442 filed Nov. 23, 2010 by Larry Deutsch, which is hereby incorporated by reference in its entirety.

### BACKGROUND

Users of mobile phones at times face a dilemma in accessing community based bulletin services. If automatic access is frequent, then battery life will suffer. If automatic access is infrequent, battery life will be extended, but at the expense of possibly obtaining information too late.

What is needed is an intelligent agent to find a compromise between these two extremes.

### SUMMARY OF THE INVENTION

In one embodiment of the invention, an application, commonly referred to as an “app,” is described. The app preferably runs on a mobile device, such as a mobile (cellular) telephone, a tablet device, a notebook computer, a laptop computer, or a wearable (e.g. smart watch) device. The purpose of the app is to connect to a community/classified posting site, search for items using user-specified sections and keywords, parse information relating to the items, select relevant data, and display selected data in a format suitable for viewing on the particular device. In addition, the app optionally can run in the background, monitoring the site for newly posted information, and informing a user of a new item. This background search permits the user to respond in a rapid and timely way to an item as it becomes available, thus maximizing the user's chances of obtaining it.

In more technical language, some embodiments of this app permit the user to subscribe to multiple concurrent channels of syndicated content published over the internet. A web services application programming interface (API) such as simple object access protocol (SOAP) is not required to be supported by the posting service. Instead, the method disclosed herein relies on a combination of web harvesting (e.g., markup language scraping) and parsing of syndicated content to extract and associate data from the posting service.

However, if an API, such as SOAP or REST, is available, this invention provides the ability to invoke the API and allows the extraction and association of this data with the syndicated content.

The user receives notification of the content which is new since the previous time that the user accessed a channel. In one embodiment, the user can select the frequency of checking for new content while the app conducts a background search.

In another embodiment, the user or system can select among network access profiles that balance a tradeoff between battery usage and user responsiveness. The relationship between battery usage and user responsiveness is termed, in this application, a covariant relationship. Covariance is a measure of how much these two variables change together. The magnitude of the covariance may not be easy to interpret; a problem which can be addressed by the invention.

The user can specify how far back in time to check for content. In addition, the user can specify a maximum number of changes to be presented.

Such an app has to overcome numerous obstacles. For example, mobile devices may have batteries of limited capacity and life, may have limited size displays, and may have limited computing memory and power. In addition, there may be network and communication issues such as limited bandwidth and unreliable network connections.

Referring to FIG. 10, a sample device display shows how, in one embodiment, the user may set up a search, via the device, of items available on the posting site. Preferably, a graphic user interface for the device comprises menu selectors such as icons, tabs, and pull down widgets.

Selector 1210, as described above, notifies the user that new search results are available. A status indicator 1305 may indicate that the device is performing background searches and show the time interval between each search, or indicate the time of the last search.

One embodiment of the display shown in FIG. 10 is a selector 1310 that facilitates a search of the posting site. The selector 1310 brings up a screen and interface that shows search options and allows the user to enter parameters for an immediate search or a background search.

Location selector 1320 brings up a screen (not shown) and interface that allows the user to narrow search results to items located within a specific geographic area, or to items located close to the user's current location. This location selection may be saved as a favorite accessible by selector 1370.

Favorites selector 1330 brings up a screen (not shown) and interface that may allow the user to select previously saved search requests, to access bookmarked search results, and to perform the following operations:
Notify other users of search request or results via email, short messaging service (SMS) messages (e.g., text messages), or other communication modes
Contact item poster via email, SMS messages, or telephone
Respond to posting service
Display a geographic map of the location of posted item
Submit an auction bid

The search keyword selector option 1340 allows the user to enter a keyword to narrow search results to those posted items whose descriptions contain the keyword.

Search category selector option 1350 allows the user to enter a general category (such as “free,” “for sale,” or “for lease”) to narrow search results to those posted items within the category.

Search sub-category selector option 1360 allows the user to enter a specific category (in this example “boats”) to narrow search results to those posted items within the sub-category.

Favorite location selector 1370 allows the user to choose a geographic area previously saved by invoking selector 1320 (see above). Selector 1320 or 1370 optionally may access a current location of the user via global positioning satellite or other geo-location mechanism to use as a favorite.

Filter selector option 1380 allows the user to further narrow search results to parameters (in this example minimum price and maximum price) within a range or other specifications.

Search selector 1390 allows the user to initiate an immediate search. A screen displaying results, as shown in FIG. 11 in one embodiment, may automatically appear.

View results selector 1392 allows the user to view the results of a background search.

Search preferences selector 1394 directs the user to one or more screens (not shown) that allow the user to display and edit various search parameters such as, in some embodiments:

Enable or disable display of thumbnails on a result screen (such as shown in FIG. 11)

Specify a maximum number of search results to return

Specify a look-back time interval (e.g., do not return items posted before a specified time)

Enable or disable background searches for newly posted items

Enable or disable visual, audible, or tactile forms of notification of new results

Set a time interval between each background search

Select a network access profile that balances the tradeoff between battery usage and user responsiveness

The time between search intervals is a trade-off, in some embodiments, between receiving search results as soon as possible after postings are listed and extending battery life of the device. The shorter the period between search intervals, the larger the drain on a battery. However, the longer the interval, the less likely the user will be able to submit a quick enough response to obtain a posted item. Obviously, this tradeoff not a factor for plugged in devices.

Another selector, a clear saved data option (not shown), may direct the user to one or more screens (not shown) that allow the user, in some embodiments, to perform one or more of the following functions:

Delete background search results

Delete favorite search requests

Delete preferred locations

Delete bookmarks and/or bookmarked results

Clear web cache

Referring to FIG. 11, a sample device display shows how, in one embodiment, the app may display search results, gathered from a posting site, to the user.

Notification selector 1210, when displayed, indicates to the user that new search results are available on the device. This app permits background searches to be performed at periodic intervals while other app's and functions are running on the device. Selector 1210 may appear on a status line while the user is running another app, while using the device for a phone call, or while the device is in idle mode. In addition to a visual selector, the user may be notified of new search results by a sound (e.g. a ring tone), a vibration, or a flashing LED, for example. Upon receiving selector 1210, the user may review updated search results.

Optional image thumbnail 1220 displays a photograph, picture, or drawing on the device of an item (e.g. a good or service), offered on the posting site, selected from a user-specified category and/or keyword. Reasons that the thumbnail 1220 may not be shown include lack of a photograph, picture, or drawing of the item on the posting site, a user decision not to show thumbnails on the device (which can reduce the size of data to be communicated from the posting site to the device and save memory on the device), image is too big to download, target website temporary not responding, temporary loss of communications, and lack of relevance of a thumbnail to the requested information.

Contents 1230 include details of the posted item. Specifically, contents 1230 may include title of the item, date and time posted, price, description, location, and condition. The most relevant details may include a short summary description and date. By “clicking” on the details, the user may select the item to display a full posting. The user may scroll through multiple postings, if they exist.

Aspects of this specification, comprising routines and data structures, in addition to contributing to the operation of the app, are relevant to other types of apps. One embodiment of the invention, included in Appendix A, comprises Java and XML user interface specifications.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a high level diagram of a method implementing the invention according to one embodiment.

FIGS. 2A and 2B combined is a diagram of a method of performing a background search of a community/classified posting service.

FIGS. 3A and 3B combined is a diagram of a method of process retry logic for handling battery and communication error problems.

FIGS. 4A and 4B combined is a diagram of an asynchronous thread to perform multiple search requests.

FIGS. 5A, 5B and 5C combined is a diagram of a procedure to execute a single search request.

FIGS. 6A and 6B combined is a diagram of a thread to perform a markup language search of the posting service.

FIGS. 7A, 7B, 7C and 7D is a diagram of a thread to perform a syndicated content search of a posting service.

FIGS. 8A and 8B is a procedure to store the search results in a table.

FIG. 9 is a block diagram of an apparatus configured to perform features of the invention according to one embodiment.

FIG. 9A is a block diagram of an apparatus configured to perform features of the invention according to one embodiment.

FIG. 9B is a diagram of multiple apparatuses communicating over a network, according to one embodiment.

FIG. 10 is a diagram of a user interface for controlling the apparatus to perform a search of the posting service.

FIG. 11 is a diagram of a user interface to display and scroll through search results.

FIG. 12 is a block diagram of a system configured to execute some embodiments of the invention.

FIG. 13 is a high level diagram of a method implementing the invention according to an alternate embodiment to that shown in FIG. 1.

FIG. 14 is a diagram of a method in the framework of loading a cell repository data store into a array of independently executing cells, and initiating a processing flow between the cells.

FIG. 15 is a diagram of a method of processing within an individual cell, in which the cell invokes a callback on the framework to perform a search operation, and then transfers control to the next cell.

FIGS. 16A and 16B combined is a diagram of a method of performing a background search of a community/classified posting service, augmenting the embodiment in FIGS. 2A and 2B.

FIGS. 17A and 17B combined is a diagram of an asynchronous thread to perform multiple search requests, augmenting the embodiment in FIGS. 4A and 4B.

FIG. 18 is a diagram of a sample two dimensional cell array.

FIG. 19 is a graph showing the battery performance from a monte carlo simulation for a “responsive” profile.

FIG. 20 is a graph showing the connection performance from a monte carlo simulation for a “responsive” performance.

FIG. 21 is a graph showing the battery performance from a monte carlo simulation for a “conservation” profile.

FIG. 22 is a graph showing the connection performance from a monte carlo simulation for a “conservation” performance.

FIG. 23 is a sample listing from a JSON cell repository file.

FIG. 24 is a sequence diagram showing a sample cell flow and the messages sent between cell components.

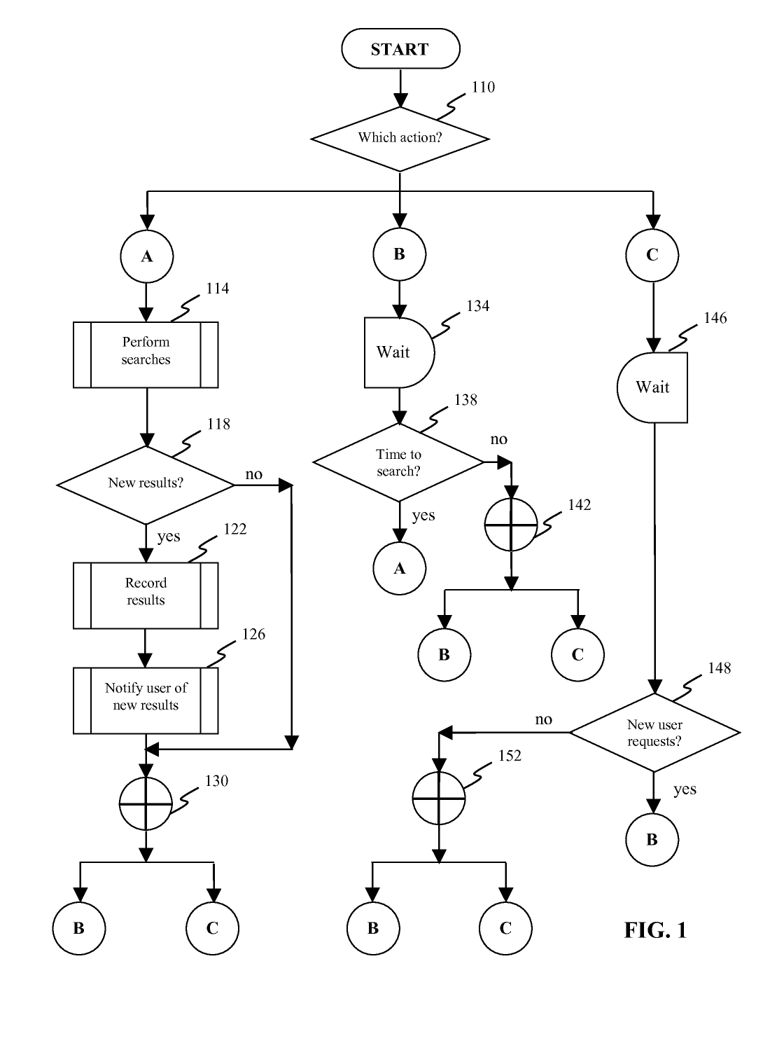

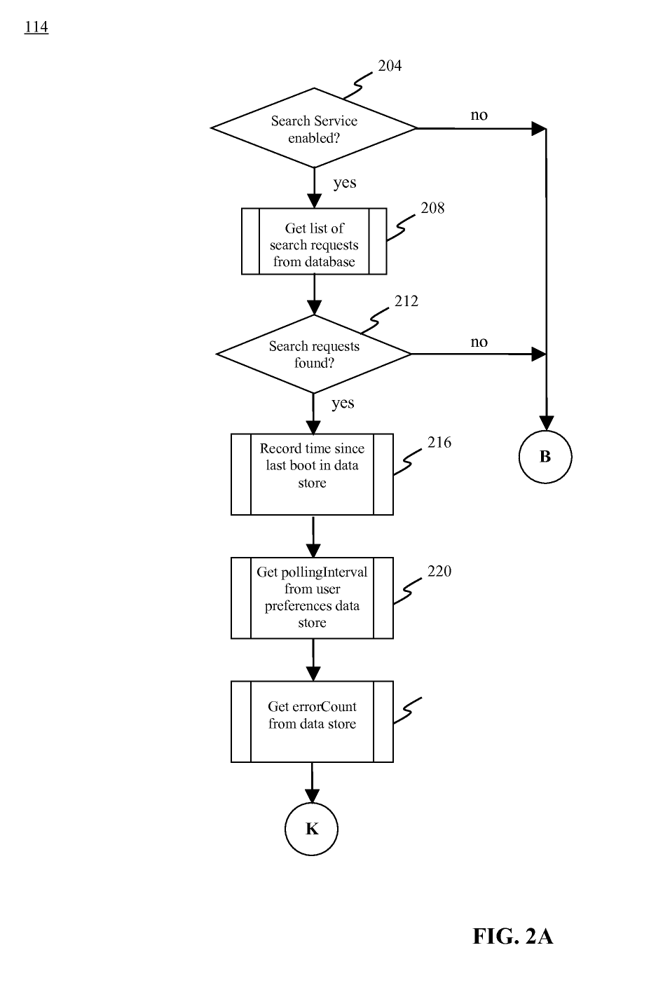

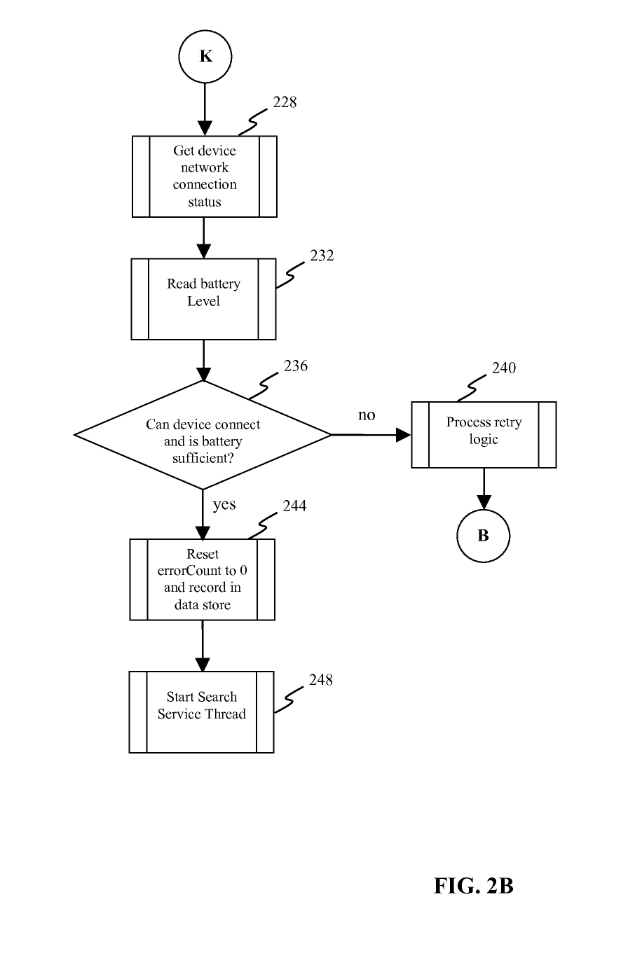

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

As used in this application, the generic term “content reference” includes the concept of uniform resource locator (URL) and equivalents.

As used in this application, the generic term “markup language” includes the concept of hyper-text markup language (HTML) and equivalents.

As used in this application, the generic term “syndicated content” includes the concept of RDF Site Summary (RSS) sometimes known as “really simple syndication” and equivalents. “RSS” is a family of web feed formats used to publish frequently updated works. RSS is a web content syndication format that is a dialect of XML 1.0. The RSS 2.0 specification was released through Harvard under a Creative Commons license on July, 15, 2003 which is available on the internet at the cyber law Harvard RSS website.

As used in this application, the term “data store” includes but is not limited to the concept of a database. A data store may be any type of information depository known in the art accessible by data processing apparatus.

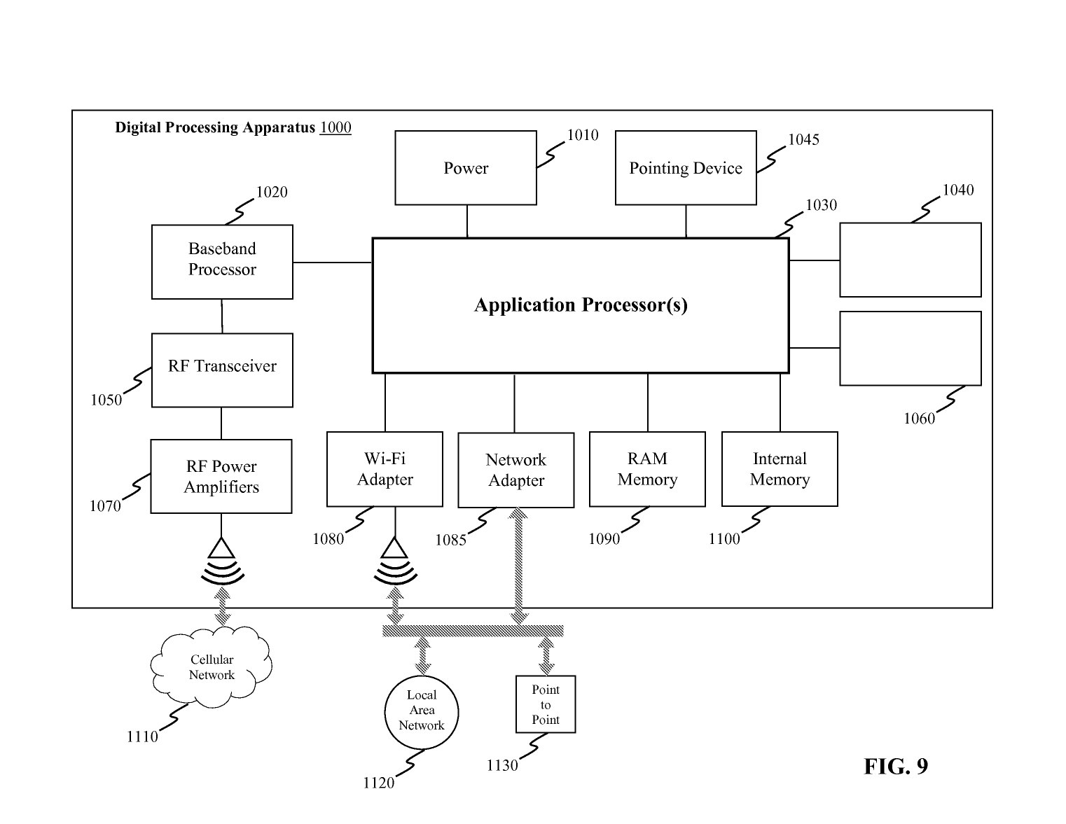

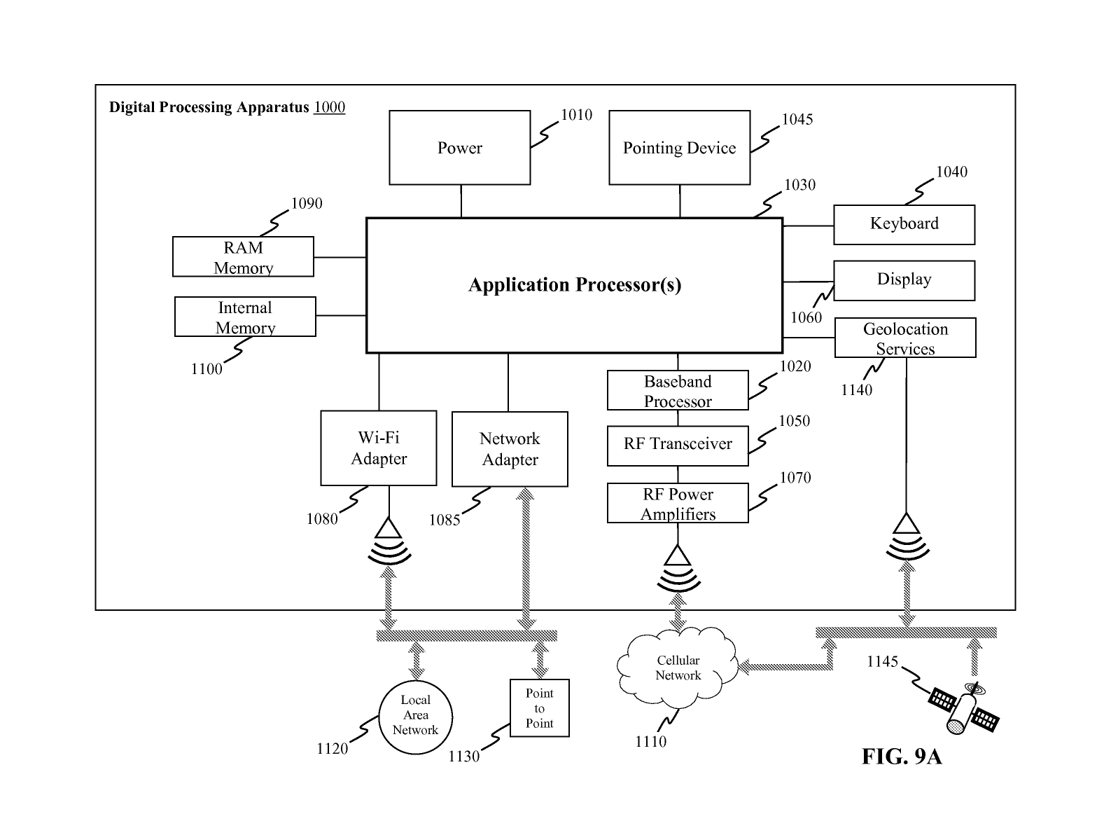

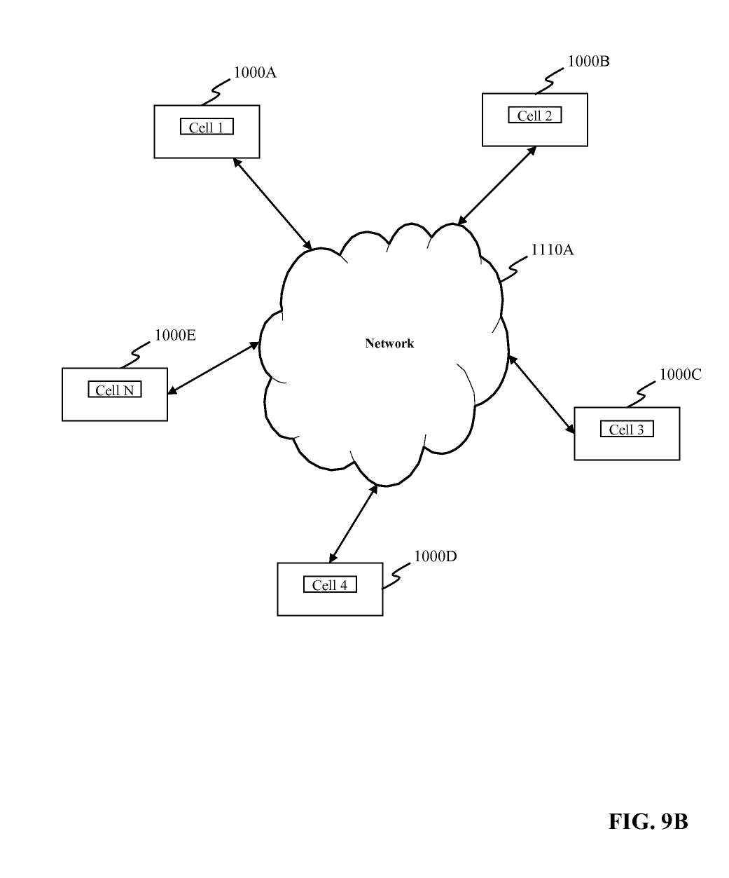

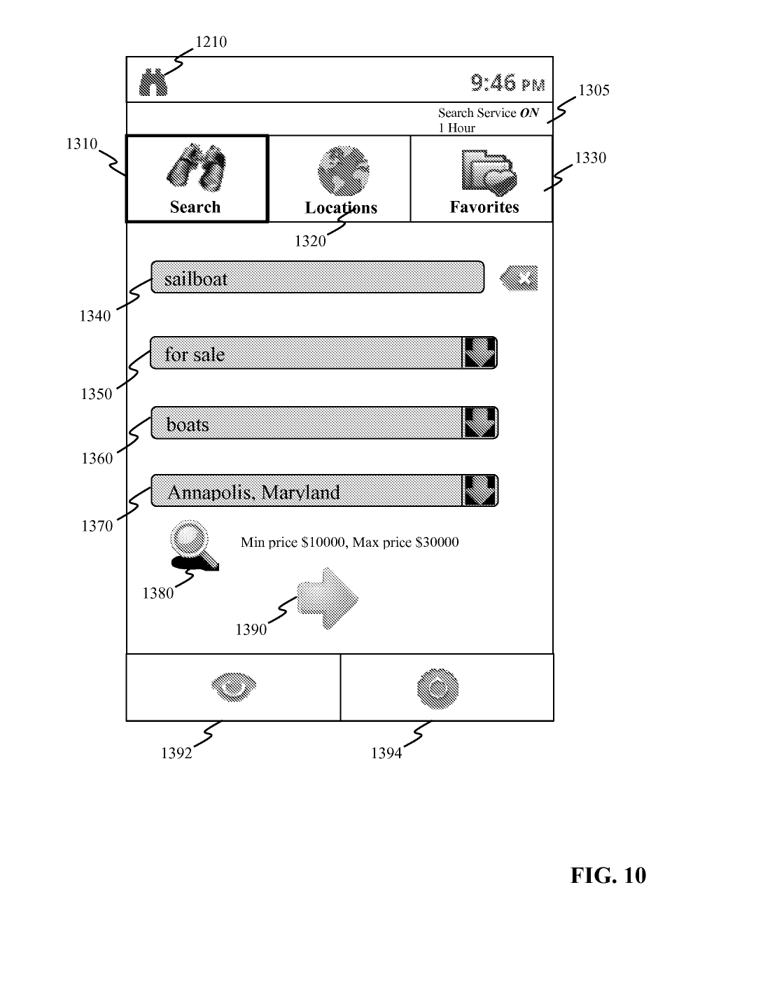

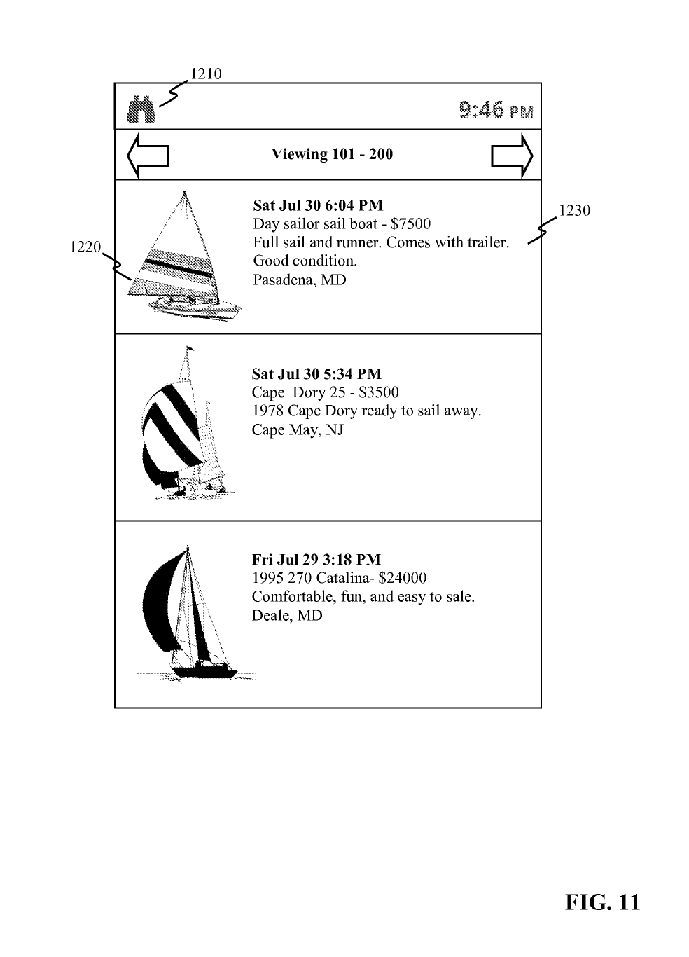

Referring initially to FIG. 9, a system is shown which includes a digital processing apparatus 1000. This system is preferably a mobile device such as a cellular telephone, notebook computer, tablet computer, laptop computer, or a wearable (e.g. smart watch) device). The example apparatus in FIG. 9A includes provision for input power 1010 (such as a battery and power management IC), application processor(s) 1030, RAM memory 1090, and internal memory 1100 (e.g., non-volatile memory such as flash memory, hard drive, CD-ROM drive, or DVD drive). Communications may be provided by optional network adapter 1085, and/or optional Wi-FI adapter 1080, to a local area network 1120 or to a point-to-point network 1130. In addition, optional connectivity to cellular network 1110 may be provided via baseband processor 1020 (a CPU that manages cellular network 1110 communications), transceiver 1050 which handles the broadcast and reception of radio signals with network or subscriber equipment, and one or more power amplifiers 1070 which increase signal power up to levels required for wireless communication. Geolocation services 1140 provides a mechanism to determine the user's current location, either through a satellite positioning system 1145 (such as GPS), or the mobile subscriber's cellular network 1110.

Electronic visual display 1060 typically comprises an LCD touch screen and preferably supports graphics. Data input may be through one or more of the following agencies: keyboard 1040 (soft or hard), touch interface or pointing device 1045, voice (not shown), disk storage (optionally comprising internal memory 1100), local area network 1120, point-to-point network 1130, and cellular network 1110.

One or more features of the computer as shown may be omitted while still permitting the practice of the invention. For example, apparatus pointing device 1045, such as a mouse, is not required where the apparatus 1000 is a cellular telephone.

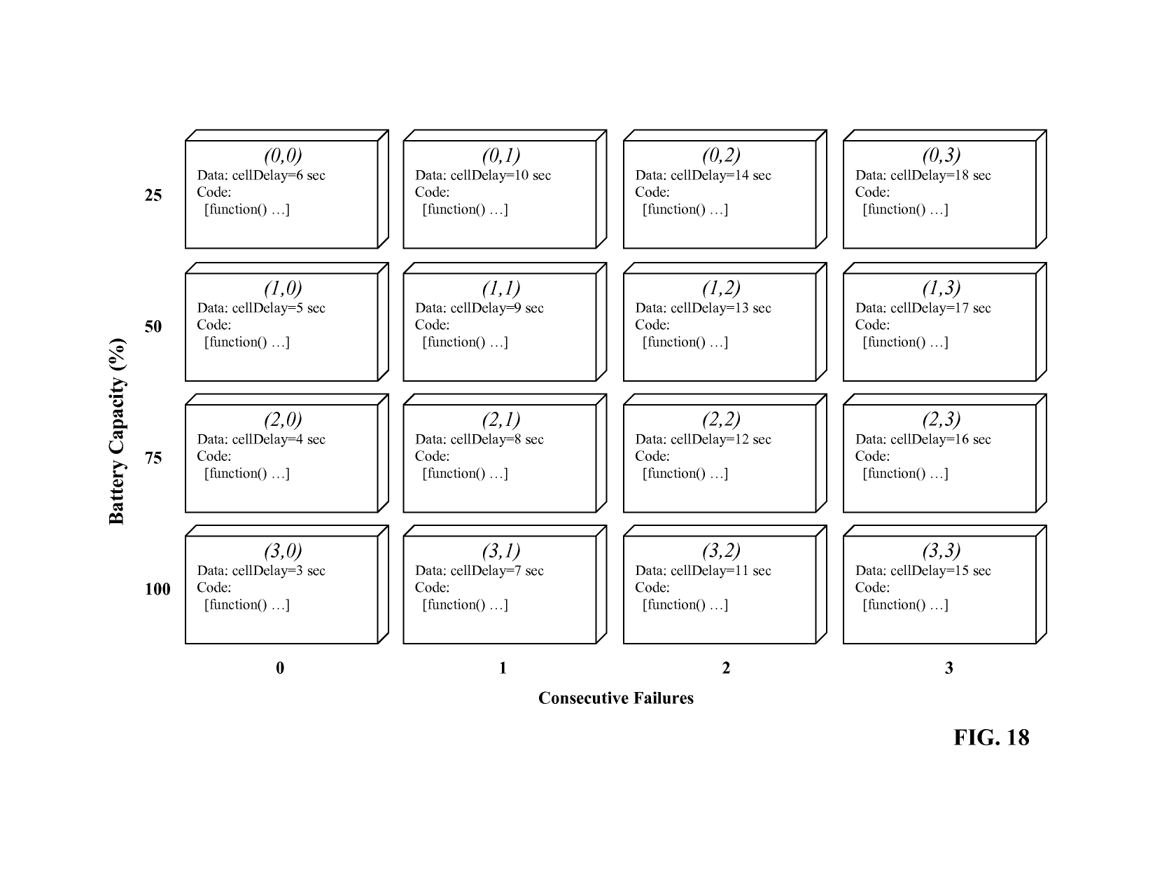

FIG. 9B is a diagram of multiple apparatuses communicating over a network, according to one embodiment. Apparatus 1000, and variants, may be duplicated and interconnected. FIG. 9B shows a common architecture: connections to a network cloud such as, for example, the internet. A number of apparatuses may be connected. Five apparatuses (1000A, 1000B, 1000C, 1000D, and 1000E) are shown as an example. Within each apparatus is a cell (Cell 1, Cell 2, Cell 3, Cell 4, and Cell N respectively). Cells are shown in FIG. 18 and described in detail in the accompanying description. Although not shown, there may be multiple cells in each apparatus, spread among the one or more processors in each apparatus.

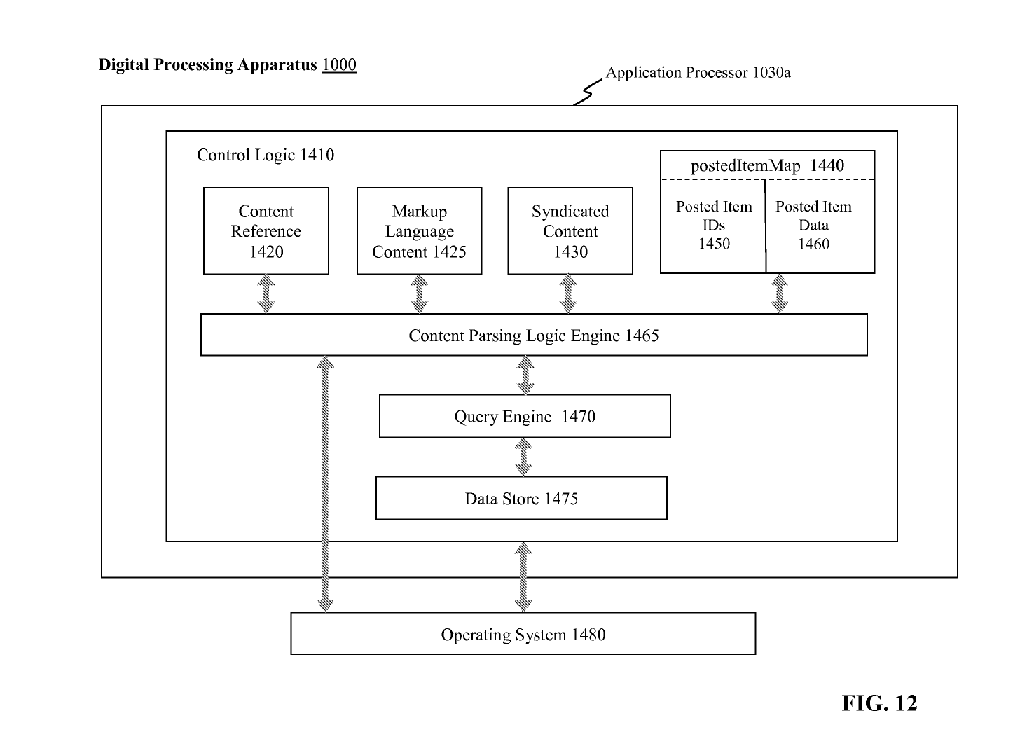

FIG. 12 is a block diagram of a system configured to execute some embodiments of the invention. Digital processing apparatus 1000 includes operating system 1480. Apparatus 1000 also comprises an application processor 1030a which in turn comprises control logic 1410. Operating system 1480 is in communication with data store 1475 (which may include but is not limited to a database). In addition, operating system 1480 is in communication with content parsing logic engine 1465. Data store 1475 is in communication with query engine 1470, such as a SQL based query system. In turn, query engine 1470 is in communication with content parsing logic engine 1465.

Content parsing logic engine 1465 generates a content reference 1420 based on user selected and/or defined preferences (e.g., parameters saved in data store 1475). Then engine 1465 uses reference 1420 in executing a first query on posting site to retrieve markup language content 1425. Next, the engine 1465 generates map 1440 where posting site item identifiers 1450 are mapped to item data 1460. The engine then uses content reference 1420 in its execution of a second query of the posting site to retrieve syndicated content 1430. This content is used to generate information to be included in appropriate item data 1460 locations resulting in a modified map 1440.

The content parsing logic engine passes the modified map 1440 to the query engine 1470 which in turn stores these results in data store 1475, if the search is a background search. Otherwise, if the search is a foreground search, these results are displayed to the user.

The flow charts herein illustrate the structure of the logic of the present invention as embodied in computer program software. Those skilled in the art will appreciate that the flow charts illustrate the structures of logic elements, such as computer program code elements or electronic logic circuits which function according to this invention. Manifestly, the invention is practiced in its essential embodiment by a machine component that renders the logic elements in a form that instructs digital processing apparatus 1000 (that is, a computer) to perform a sequence of function steps corresponding to those shown.

Logic elements may be contained on a computer program product which includes but is not necessarily limited to a disk, volatile or non-volatile memory, flash memory, and ROM for storing program modules. Program modules may comprise a computer program that is executed by processor(s) 1030 within the apparatus 1000 as a series of computer-executable instructions. In an illustrative embodiment of the invention, the computer-executable instructions may be lines of compiled Java code.

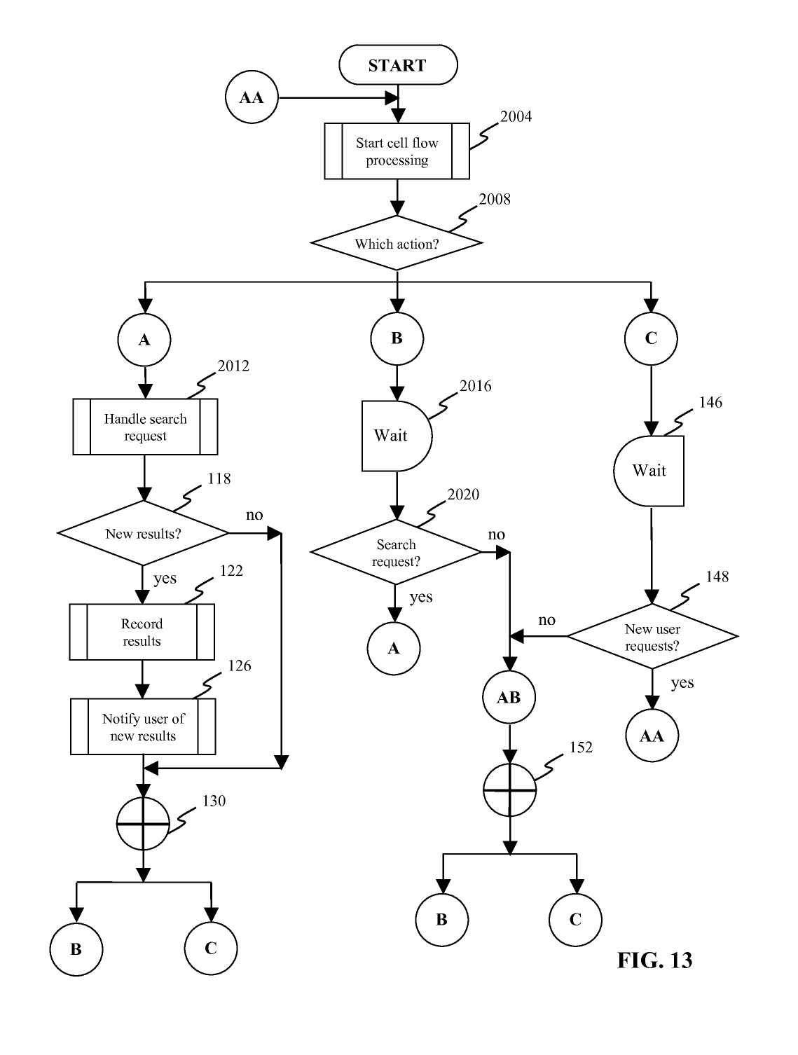

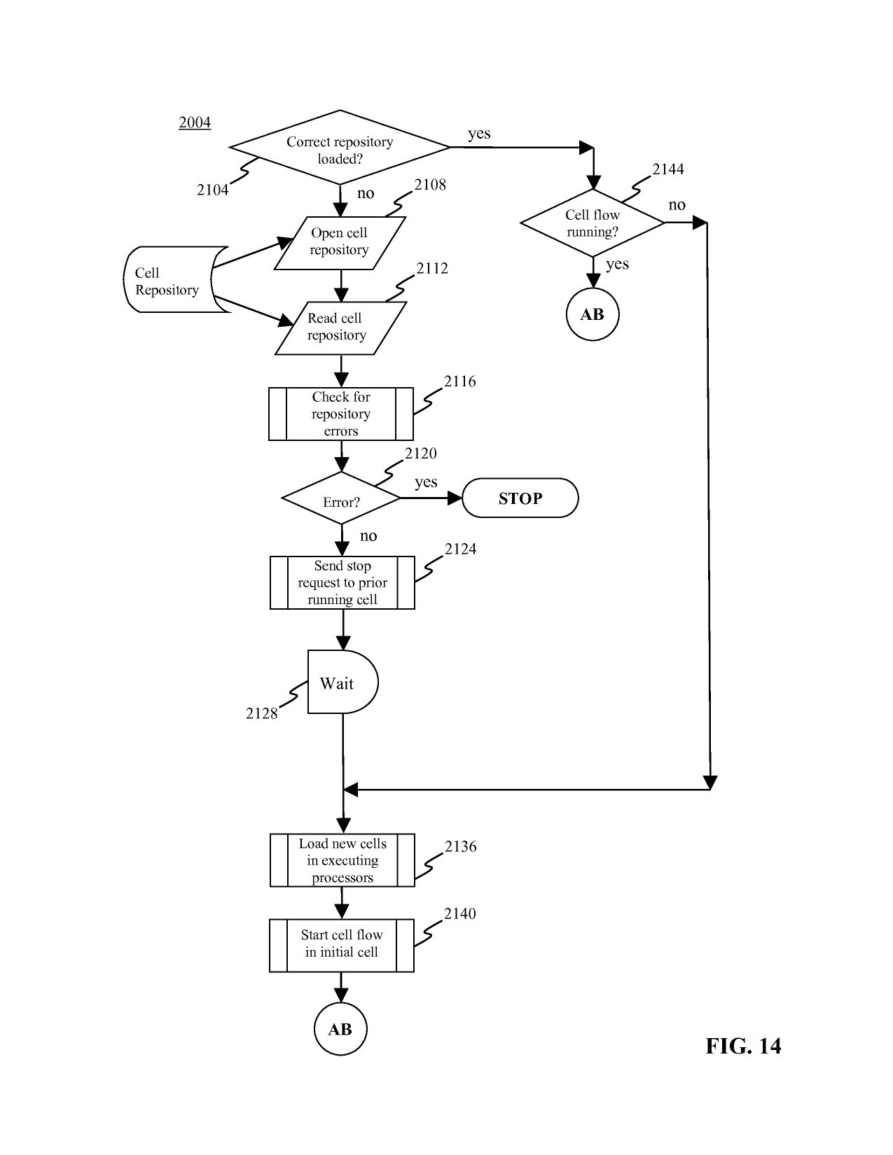

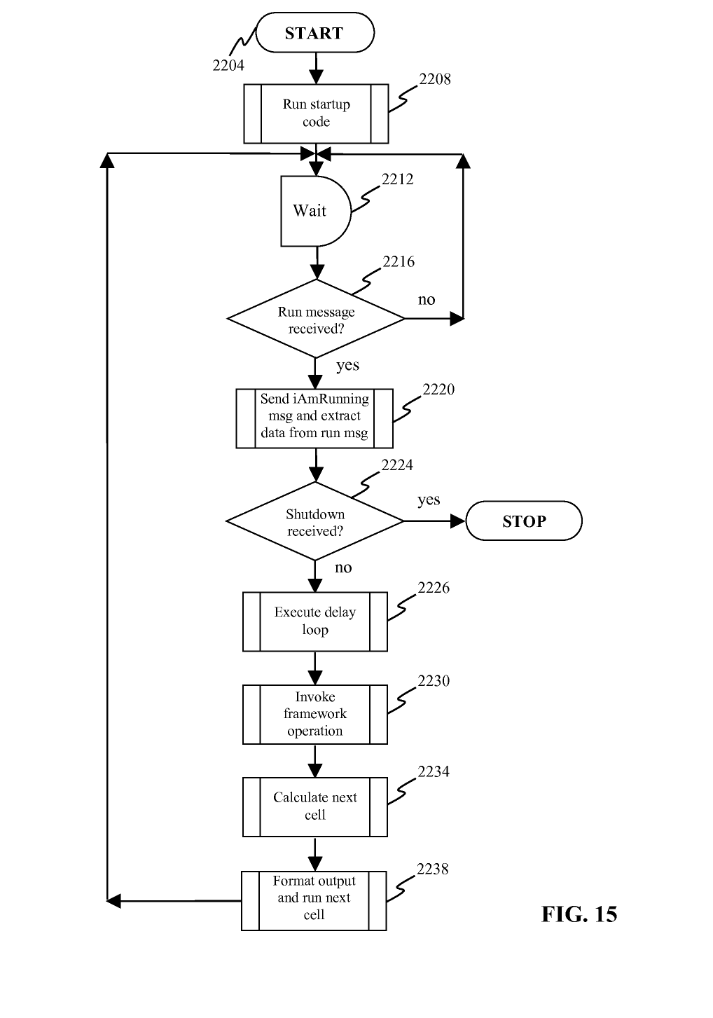

FIG. 13 is a top level view of a foreground and background search method. Step 2004 is a high level representation of a method to load cells (which contain data and code) into a multi-dimensional array of processors and to initiate a state flow between cells in the array. The cells contain independently executing units of code, which run sequentially and provide a flow used to control the timing of network access and to regulate battery usage. The initialization of the cells and startup of the cell flow by the main processing code, herein referred to as the framework, is shown in detail in FIG. 14. The logic of the code which is independently executing in the cells is shown in detail in FIG. 15.

Step 2008 is a scheduler that decides which action to perform. Options include performing a foreground or background search at step 2012, accepting user requests at step 146, or entering a sleep state at 2008 prior to running a search. Foreground searches are invoked by the user making a request via the device's user interface. Background searches are initiated in one embodiment of this intervention by an executing cell making a request to the framework. In another embodiment, background searches are initiated when a user-specified search frequency period has expired.

Step 2012 is a high level representation of a method for initiating a foreground or background search (shown in detail in FIG. 14). At step 118, if new search results are found, they are processed. Otherwise, proceed to step 130 which in turn proceeds to sleep state or to a wait state for user input at step 146.

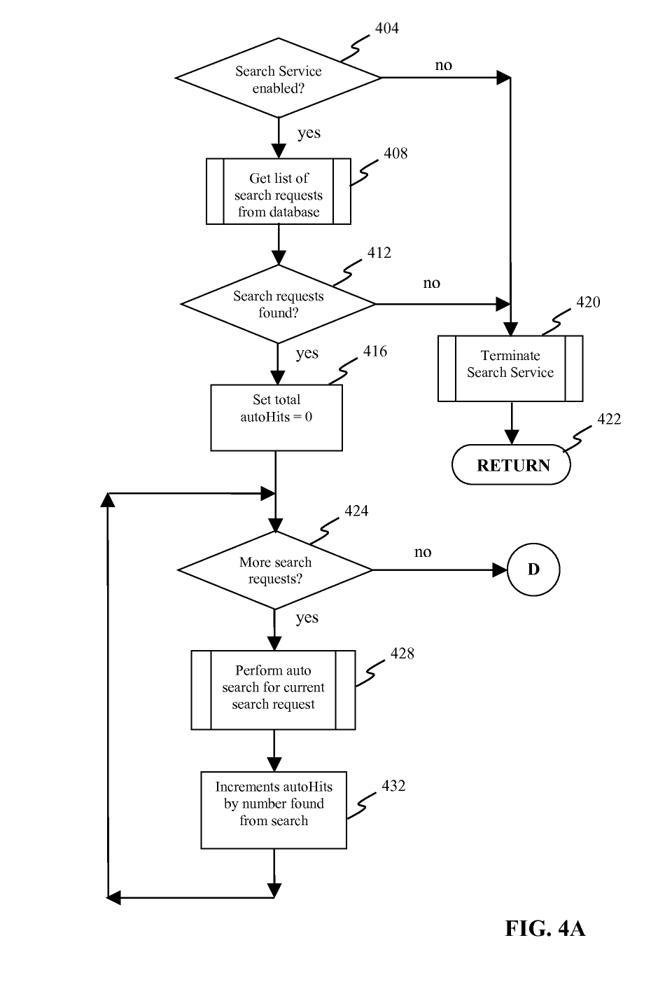

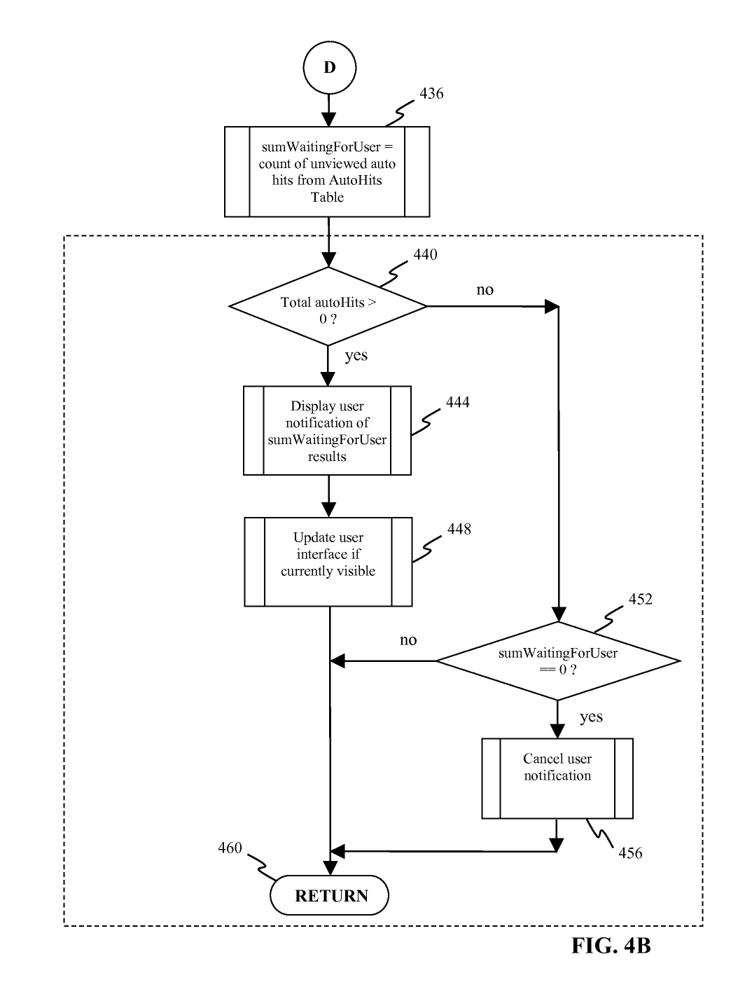

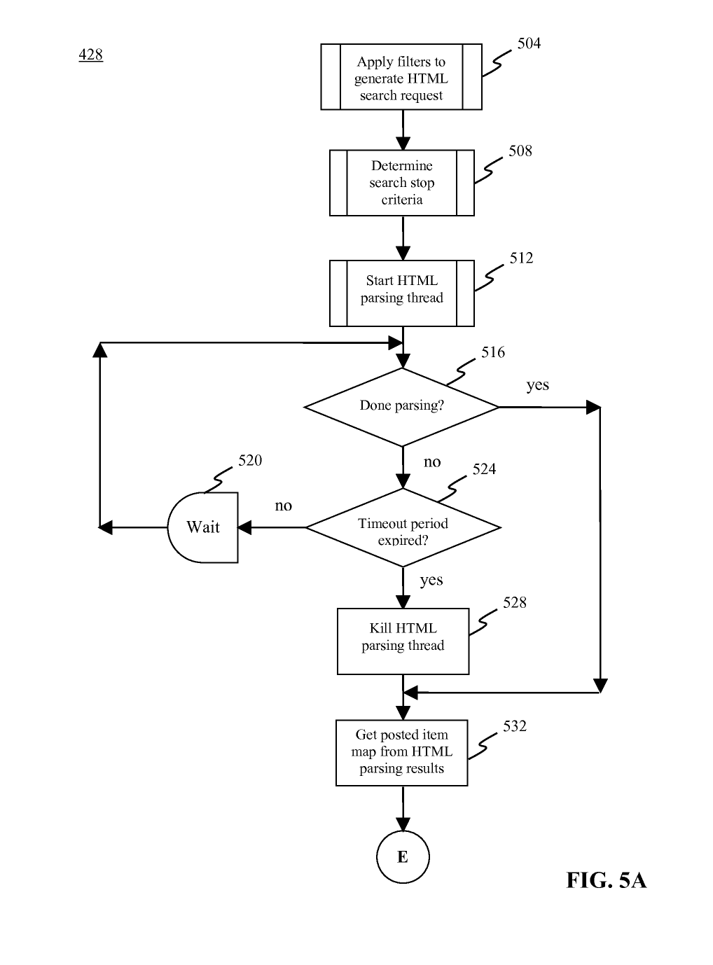

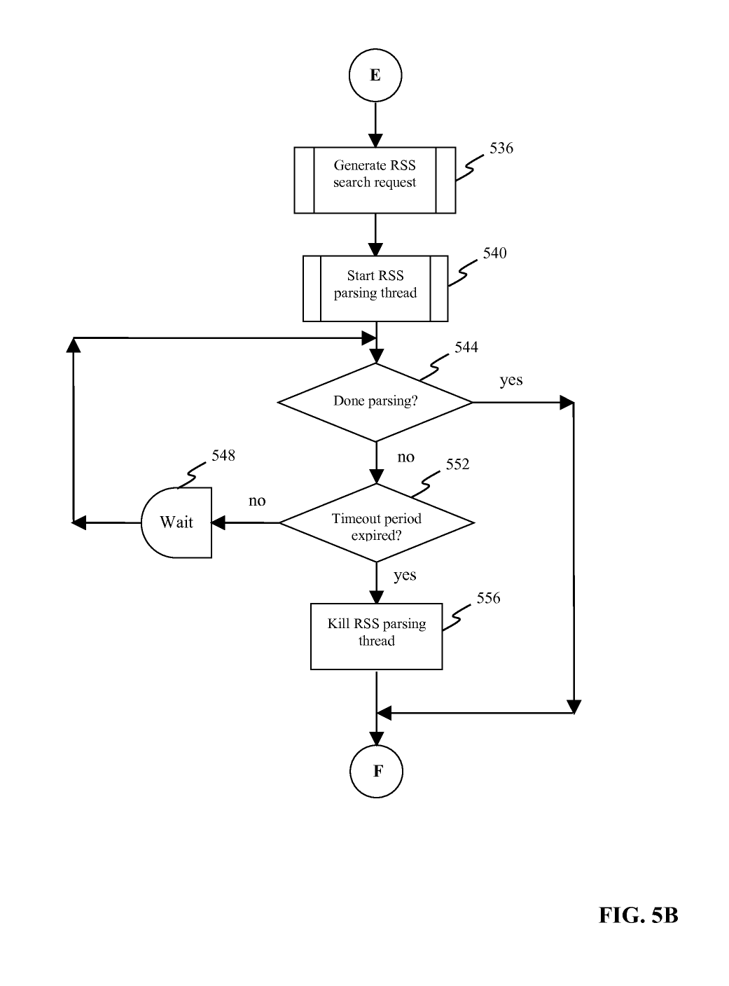

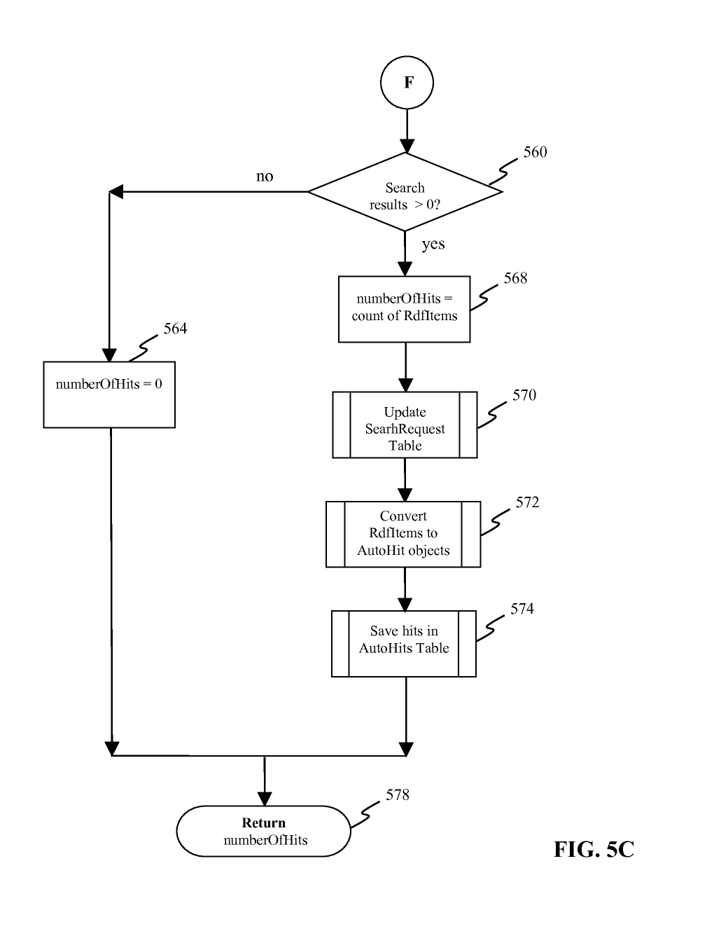

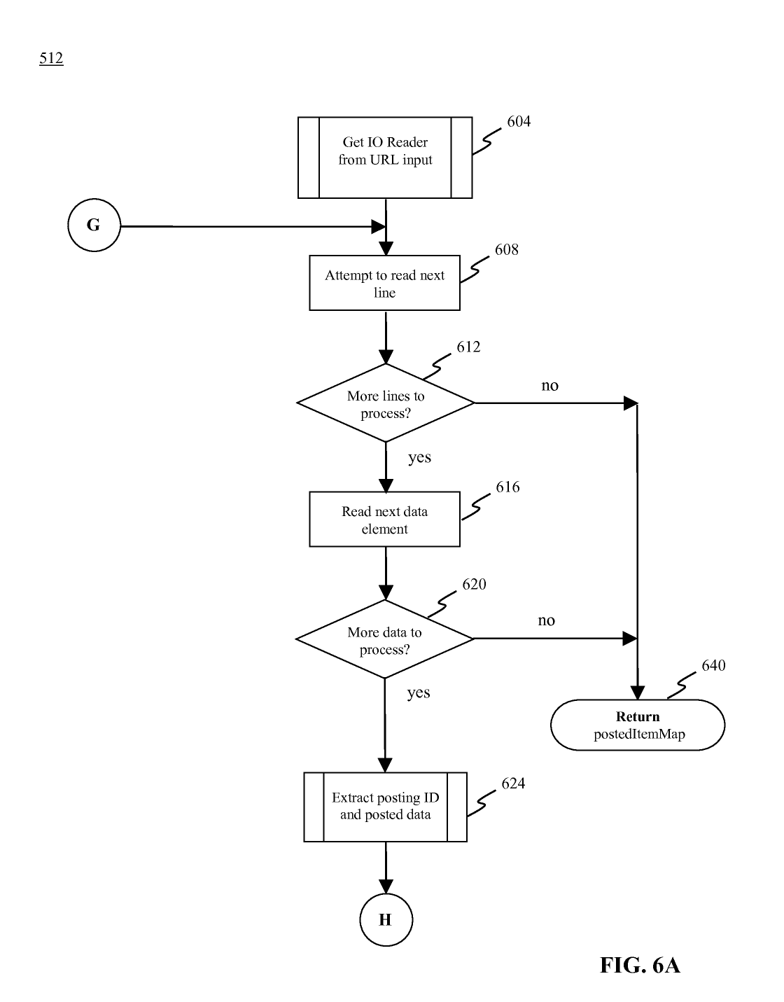

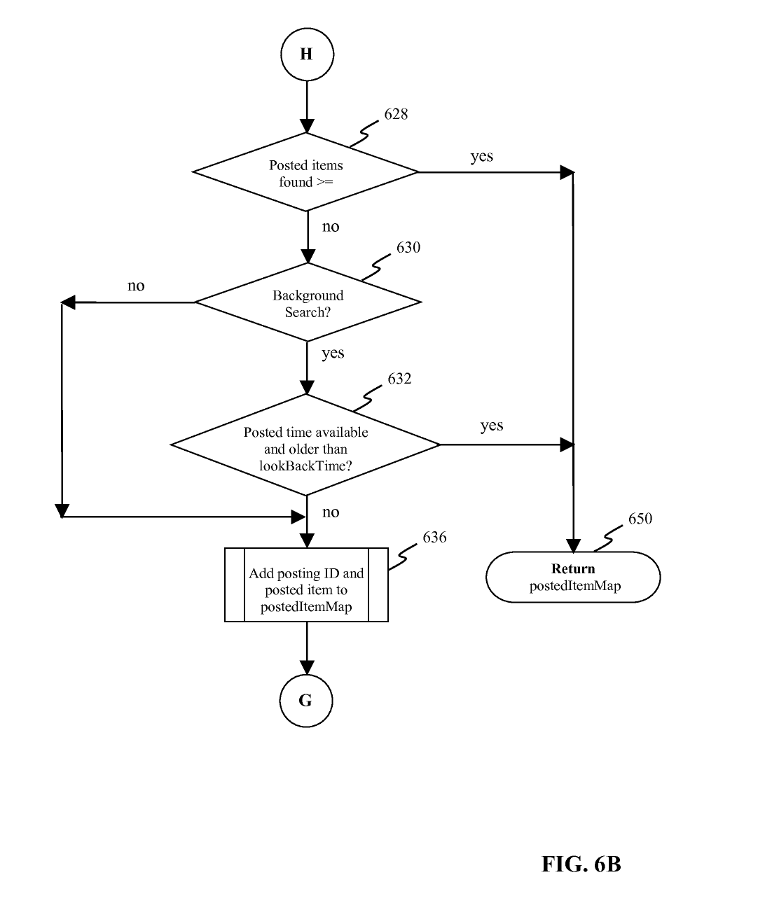

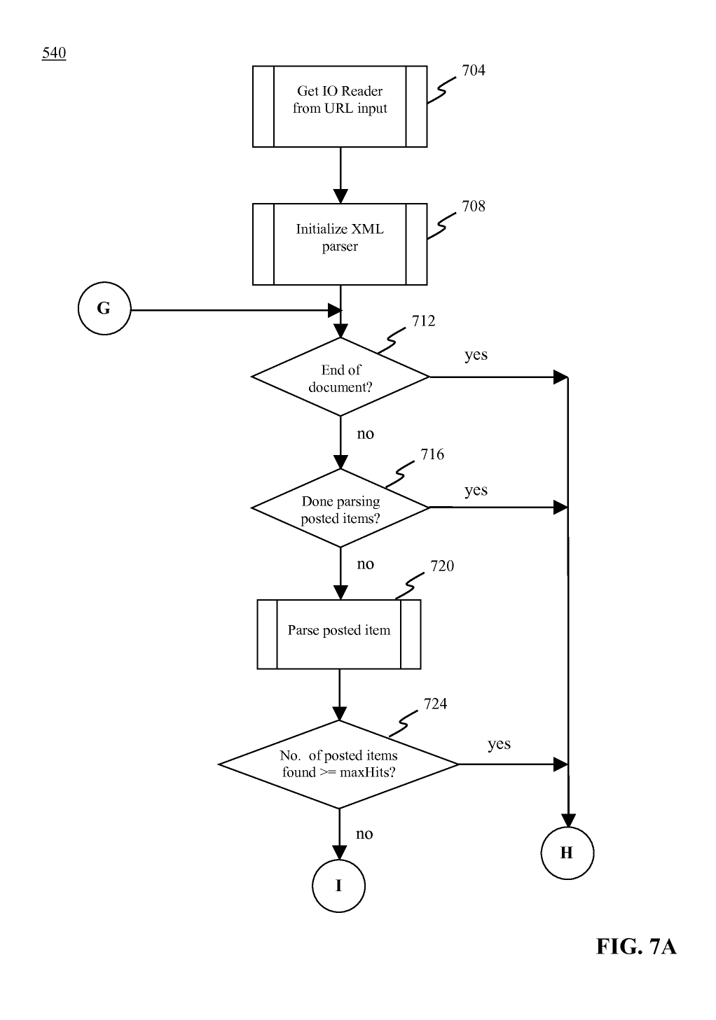

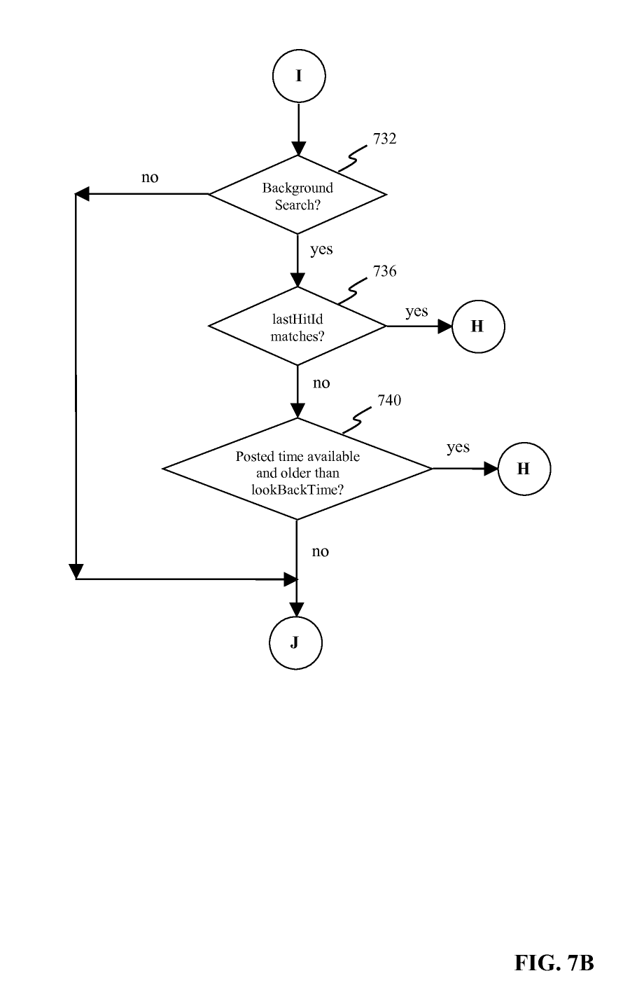

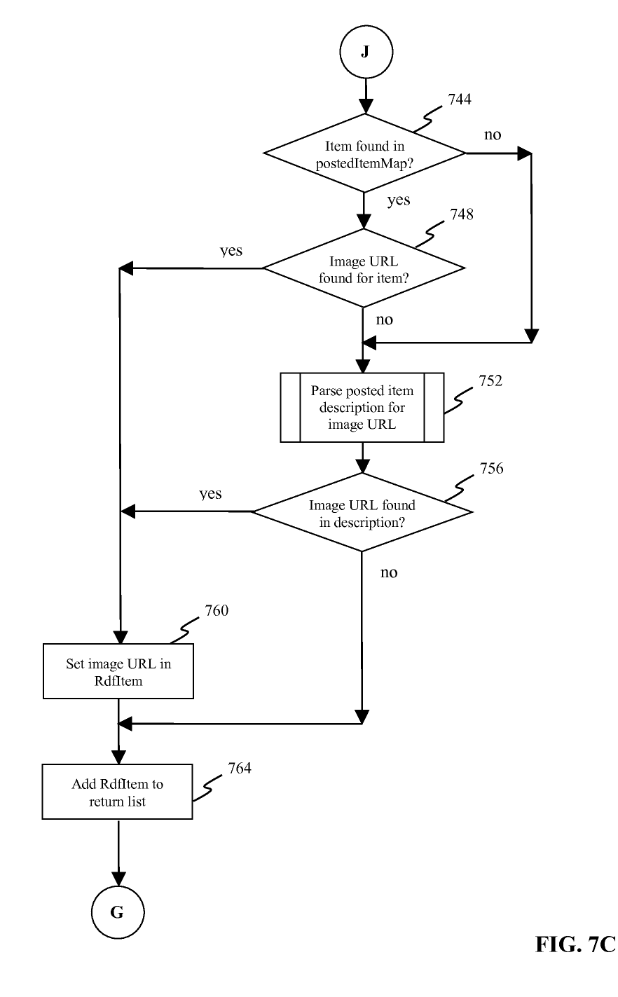

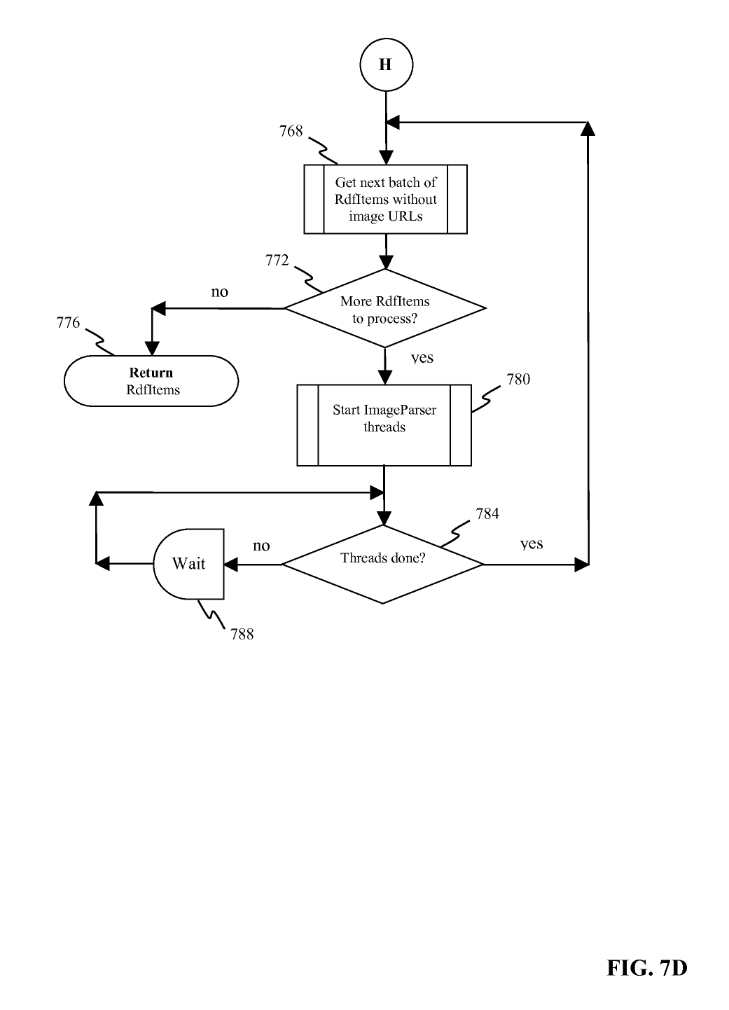

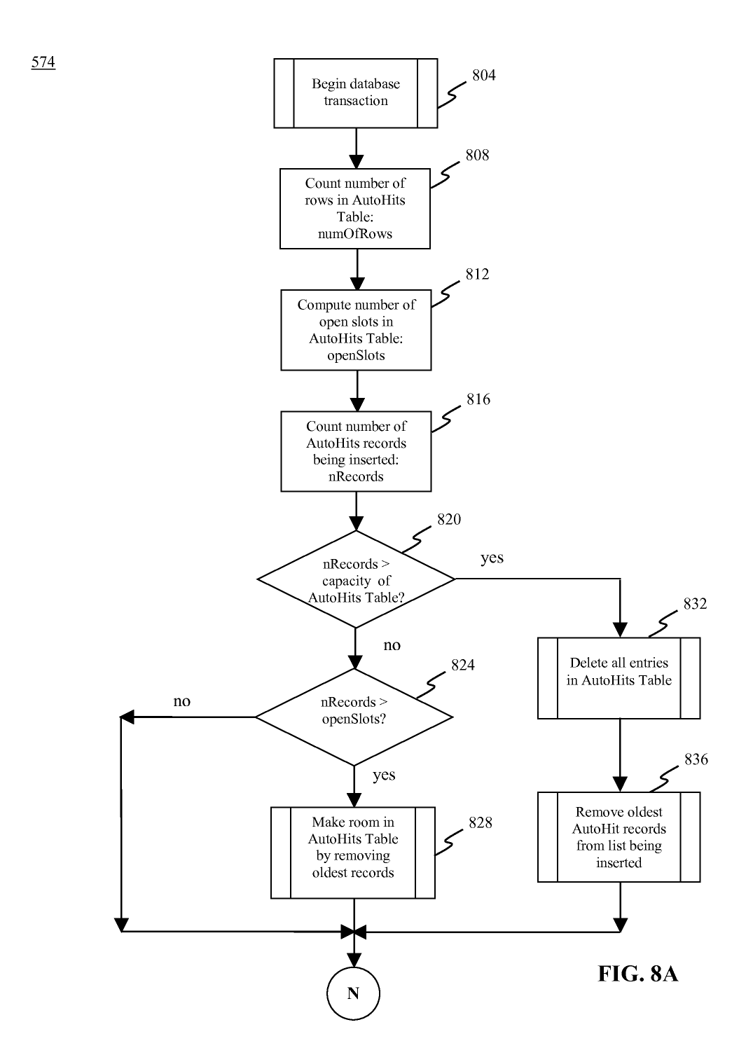

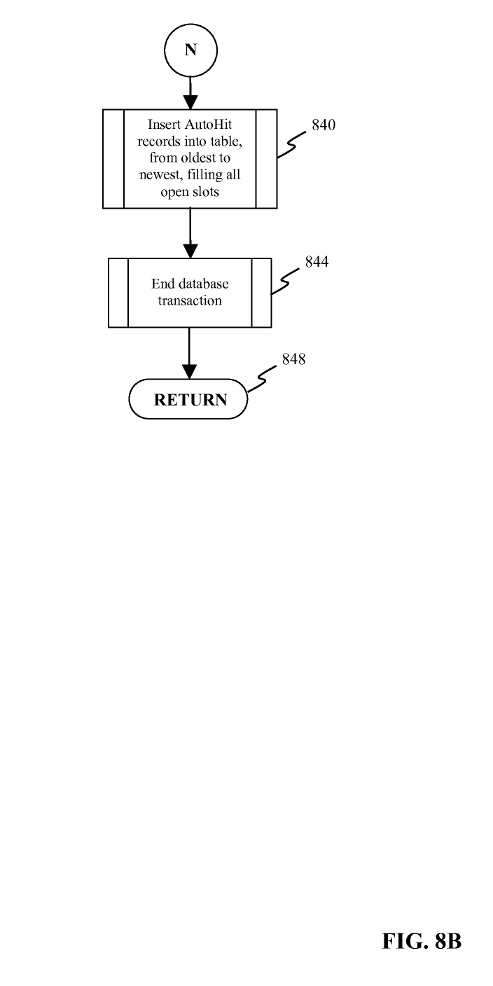

If there are new results at step 118, record the results in a table at step 122 that executes the steps 804 to 844 (returning to step 122 at step 848) (see FIGS. 8A and 8B and accompanying description). Then the user is notified of new results at step 126 that executes the steps 440 to 456 (returning to step 126 at step 460) (see FIG. 4B and accompanying description). This notification, in some embodiments, can be a display of a selector in a status area, a sound, a flashing LED, a vibrate alarm, or notification “widget” on the user's home screen. As defined in the internet online service Wikipedia: “In computer programming, a widget (or control) is an element of a graphical user interface (GUI) that displays an information arrangement changeable by the user, such as a window or a text box. The defining characteristic of a widget is to provide a single interaction point for the direct manipulation of a given kind of data. In other words, widgets are basic visual building blocks which, combined in an application, hold all the data processed by the application and the available interactions on this data.”

Some embodiments of this invention display search results via a widget on a pop up window while the user is executing other applications.

Upon exiting sleep state 2016 (when a message from a cell is received to perform a search, a user-specified search frequency period has expired, or the user requests a foreground search), the process proceeds to step 2012. Otherwise a decision is made to either proceed to sleep state 2016 again or to wait state step 146. Upon exiting the wait state step 146, it is determined at step 148 whether there is a new user request. If there is a request, the process proceeds to sleep state 2008 to wait for the next time to search. Otherwise, the process may proceed either to wait again for user input at step 146 or to sleep state 2016 for the next time to search.

FIG. 14 shows one embodiment of the invention, in which the timing of network requests to perform automatic searches is controlled by a flow of code executing in a array of independently executing cells.

On a mobile device, there is a tradeoff between system responsiveness and battery consumption. The more often a network request is made, the higher the battery consumption. Managing the tradeoff between battery consumption and system responsiveness is further complicated by the unreliable nature of mobile network communications. In order to conserve battery, it is desirable to increase the time between search requests when the communications network or posting service is unreliable. Also, it might be desirable to increase the time between network requests, when the battery capacity becomes less than certain thresholds. Other variables determining battery performance include, but are not limited to, battery temperature, number of battery charge/discharge cycles, and downlink signal strength. It is difficult for the user to account for all of these variables in determining an optimum balance between battery consumption and desired responsiveness.

A problem to be solved by some embodiments of the present invention is to provide user-selectable profiles of network usage that fulfills the desired operational characteristics. For example, a “responsive” pattern can be provided, that generates more frequent search results at the expense of higher battery usage. On the other hand, a “conservation” pattern can be provided that preserves battery capacity at the expense of less frequent search results.

FIG. 18 is a diagram of an example in which network request timing is controlled by the flow of code between independently executing cells. A cell consists of data and code that runs within its own execution environment. In this example, there is a 4×4 array for a total of 16 cells. The vertical axis represents remaining battery capacity, which is obtained by the cell in response to a network request submitted to the framework. The horizontal axis represents the number of consecutive network failures, which is maintained by the cell code and passed between cells. The cells run sequentially, with each cell determining the delay (cellDelay) time before requesting a network operation. Each cell also determines which cell to invoke next, based on rules in the cell code. Criteria used by the rules can include, but is not limited to:

Environmental variables obtained from the framework (e.g. battery capacity, battery temperature, number of battery charge/discharge cycles, and downlink signal strength.)

Past history of the cells visited

Number of consecutive error or success statuses received from the framework when performing a network operation

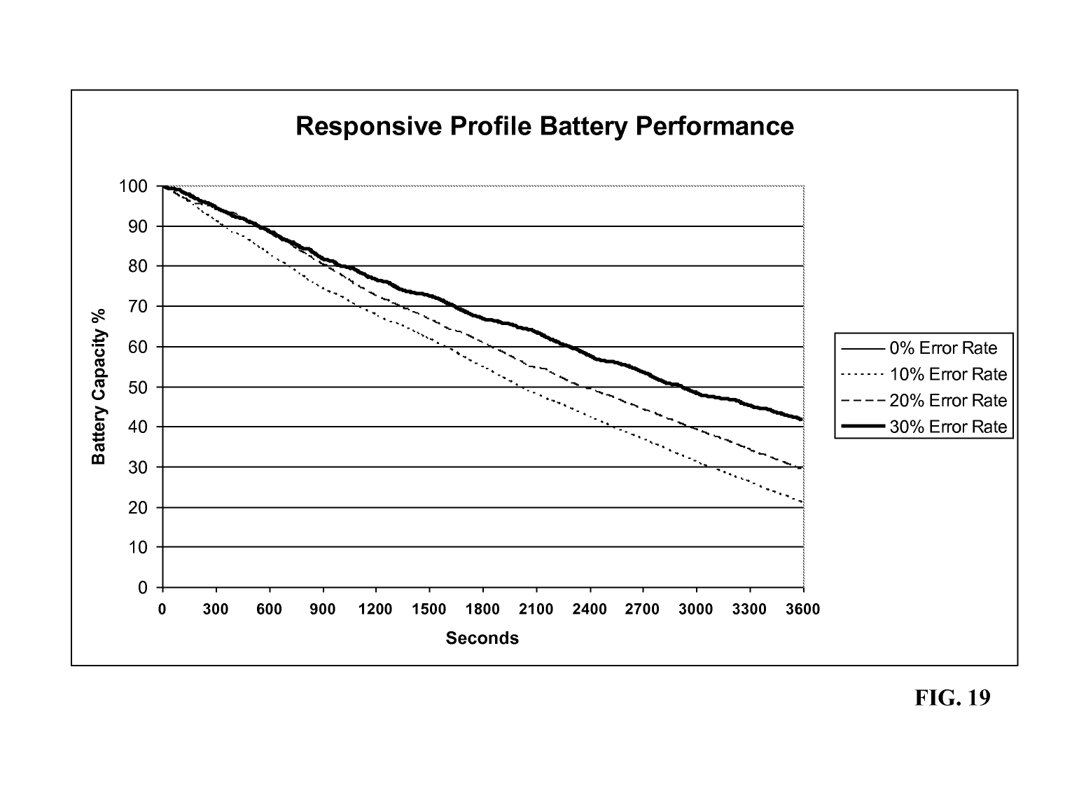

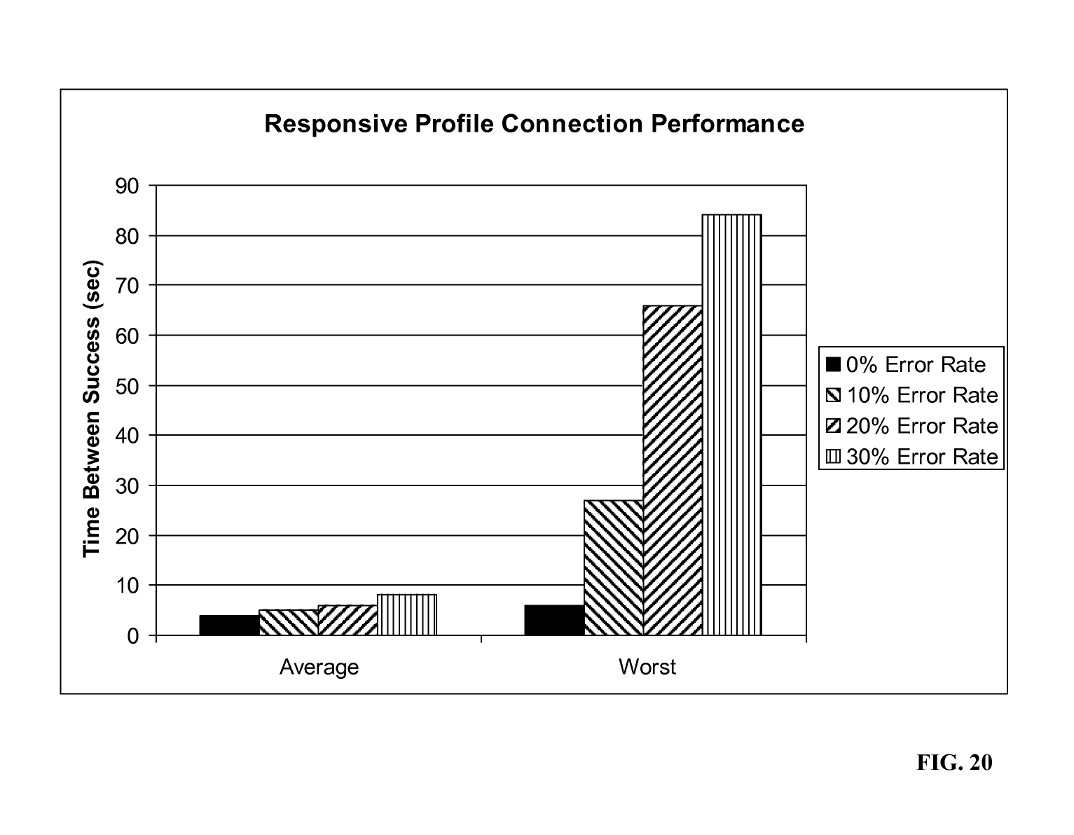

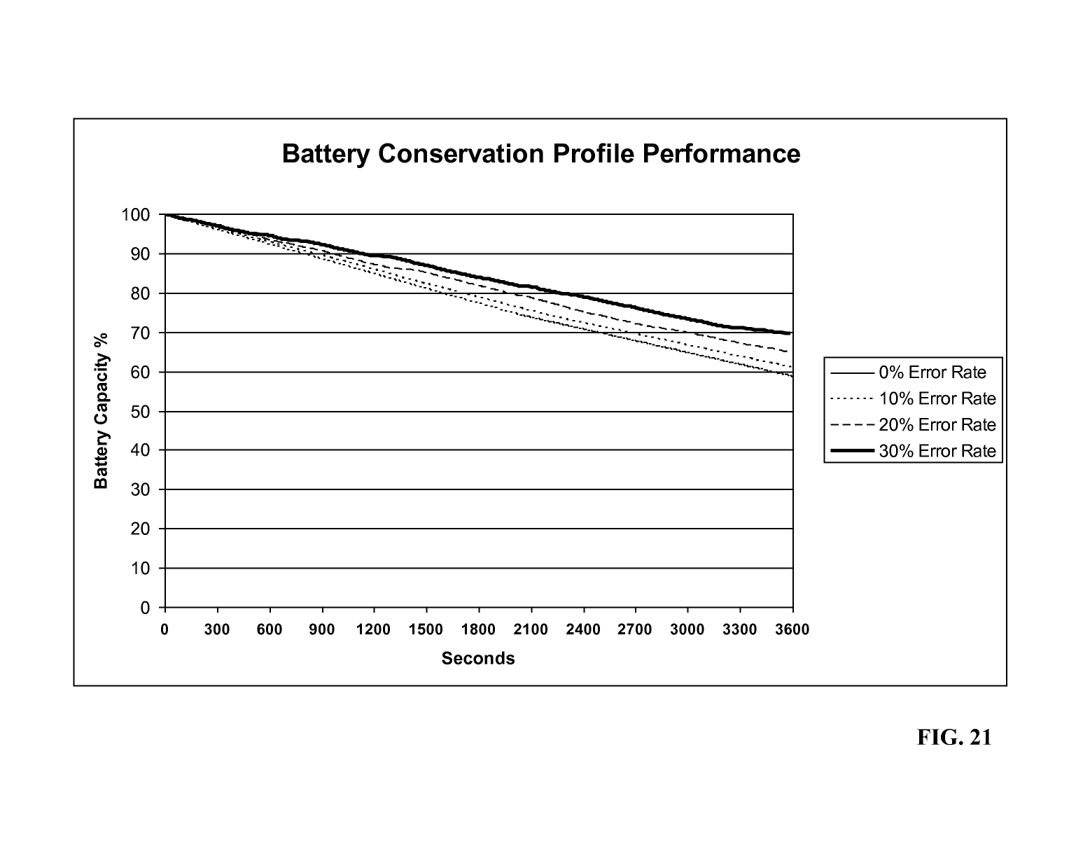

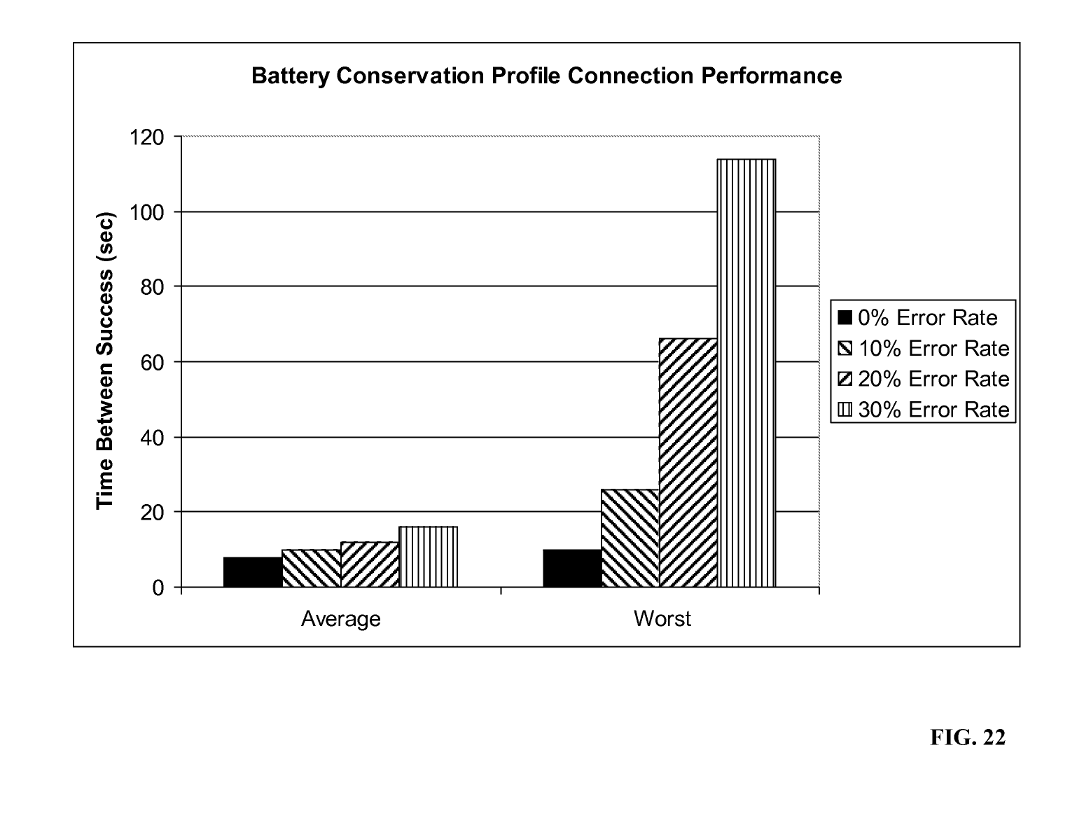

FIG. 19 contains sample battery performance results of a monte carlo simulation for a responsive profile, modeled at various network error rates. FIG. 20 contains response statistics (average and worst time between success statuses) for the sample shown in FIG. 19. FIG. 21 contains sample battery performance results of a monte carlo simulation for a battery conservation profile, modeled at various network error rates. FIG. 22 contains response statistics (average and worst time between success statuses) for the sample shown in FIG. 21.

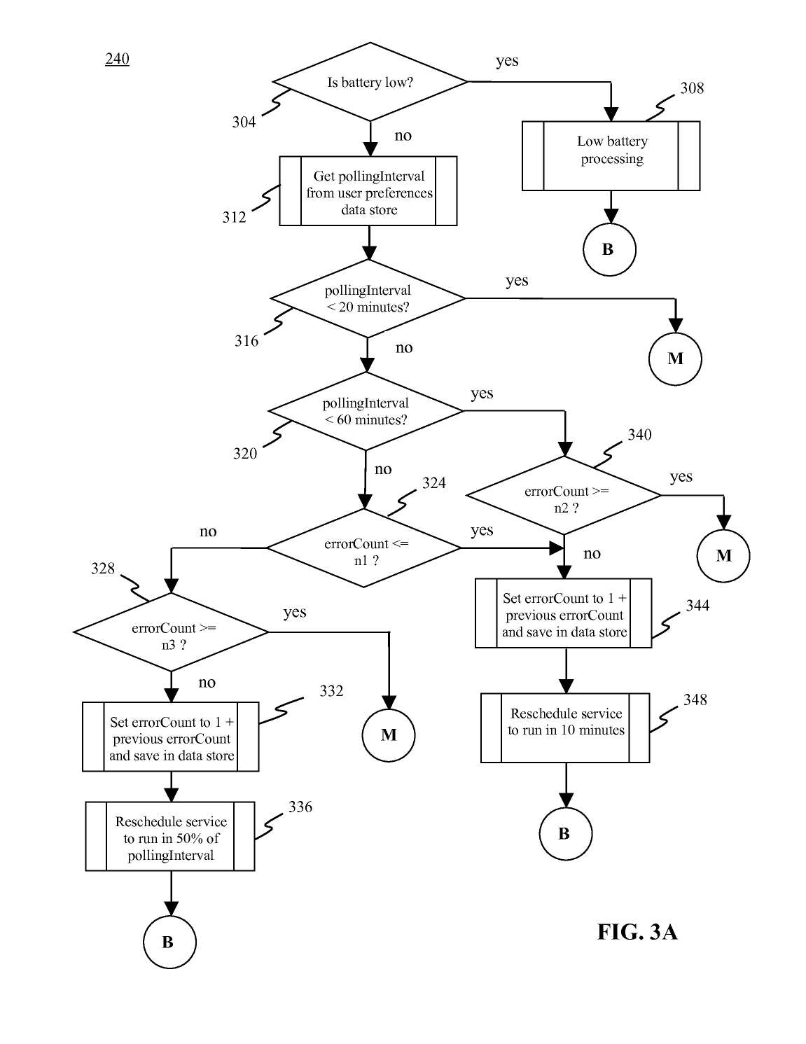

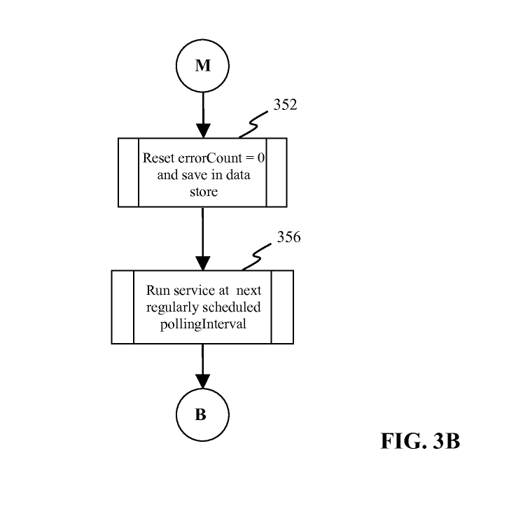

These examples illustrate the tradeoffs between battery performance and system responsiveness under different error conditions. The responsive profile indicates lower average and worst case response times, but faster battery drain. The battery conservation profile indicates lower battery drain, but higher average and worst case response times. Thus, by simply selecting a different profile (and loading a different cell repository), the user has the ability to significantly change battery and response performance characteristics without having to understand the complexities of the contributing factors. This flexibility also avoids having to hardcode custom retry logic for different environmental conditions. For example, this embodiment obviates the complexity of the hardcoded logic shown in FIGS. 3A and 3B.

An additional benefit of the invention is that the logic of when to perform the search and how to perform the search are maintained in separate code bases (i.e. cell code and framework code). This design adheres to the “separation of concerns” principle, and makes the code easier to test and maintain.

The invention is not limited to a two dimensional array, but in fact support multi-dimensions. For the example in FIG. 18, a third dimension “number of discharge cycles” could be incorporated, which would allow the performance characteristics to be more finely tuned by taking into account battery aging considerations.

Continuing at step 2104 in FIG. 14, a decision is made whether the correct cell repository is loaded, by reading the currently selected profile type from the data store. The user has the ability to select a different profile type at the user input wait state 146, resulting in the need to load a new cell repository. In addition, the code should load a default repository at startup in order for search requests to be submitted. If the correct repository is loaded, a decision is made at step 2144 about whether the cell flow is running. If the cell flow is running at step 2144, then it is not necessary to load the cell repository, and processing can proceed to sleep state 2016 again or to wait state step 146. If the correct cell repository is loaded but the cell flow is not currently running, the processing can skip to step 2136 to load new cells into the executing processors. If, at step 2014 the correct cell repository is not loaded, the cell repository should first be opened for reading.

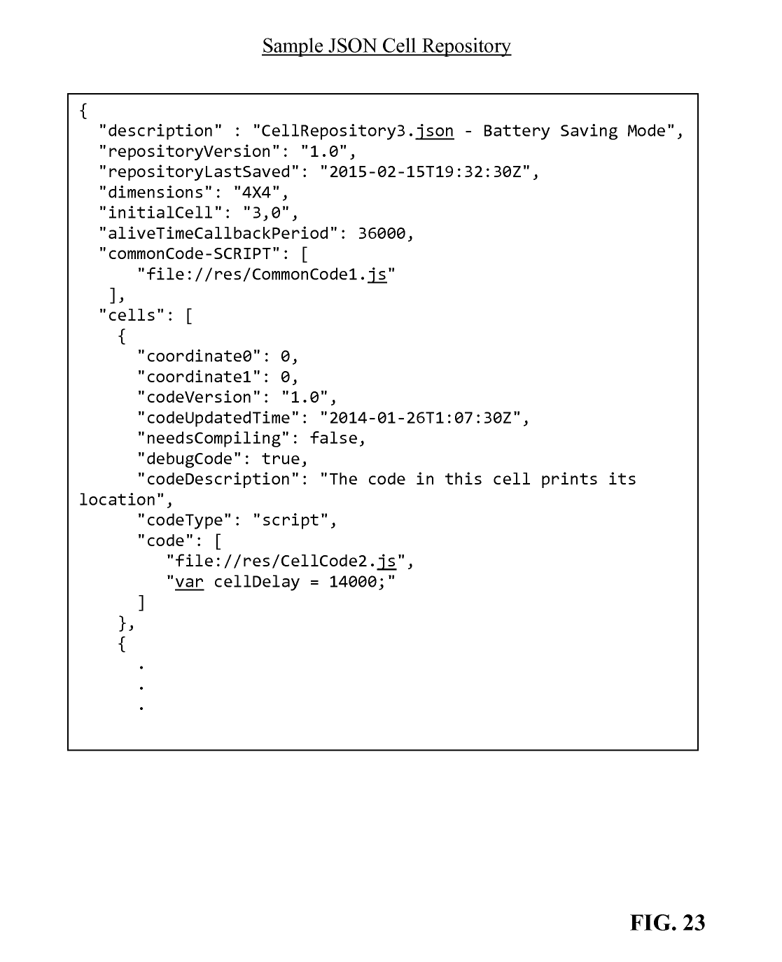

At step 2108, the data store containing a cell repository is opened for reading. In one embodiment, the cell repository is backed by a JavaScript Object Notation (JSON) file. FIG. 23 contains an example of the content of a JSON cell repository file. A cell repository contains data applicable for the entire multi-dimensional array, and data for each individual cell. The data for the entire array may comprise:

“description”—Short description of the contents of the repository.

“repositoryVersion”—Repository version string.

“repositoryLastSaved”—Time that the repository was last saved.

“dimensions”—Number of elements in each dimension. For example, the string “4×4” indicates a two dimensional array with 4 rows and 4 columns.

“initialCell”—Cell that the flow starts in. For example, the string “3,0” indicates that the flow starts in the forth row and first column. Note that coordinate indexing is zero-based.

“aliveTimeCallbackPeriod”—Heartbeat time interval that indicates how often an “iAmAlive” message to the framework should be made by the executing cells.

“commonCode-[TYPE]”—Optional common code elements that can be available for usage by all cells utilizing the specified code TYPE. Valid code types include “SCRIPT” (e.g. interpreted code such as JavaScript), “COMPILABLE” (e.g. C source code that must be compiled into a loadable binary), and “BINARY” (a loadable binary). For example, all cells implemented using a scripting language can utilize the common scripting code specified by “commonCode-SCRIPT”, if specified. If the first line starts with a “file://” URL, then code read from the local file system will be prepended to any subsequent lines of source code. In the case of BINARY code, providing a link to a file is the only valid option.

“buildScript-[TYPE]”—Optional scripts containing operating system commands that can be used to compile and build the cell code of the specified type on the cell processors.

Every cell in the array that can be invoked during the flow must be populated. The data for each cell may comprise:

“coordinate0”—First coordinate of the current cell.

“coordinate1”—Second coordinate of the current cell.

“coordinateN”—N'th coordinate of the current cell, if there are more than two dimensions in the array. For example, coordinate0=0, coordinate1=0, coordinate2=0 indicates coordinates (0,0,0) of a three dimensional array.

“processorldentifier”—String that identifies the processor that the cell executes on. One or more cells can execute on the same processor.

“codeVersion”—Version of the code in this cell.

“codeUpdatedTime”—Time that the code was last updated.

“needsCompiling”—True if the cell code needs to be compiled before it can be executed, false otherwise.

“debugCode”—True if the code should log debug statements.

“codeDescription”—Optional description for the code in this cell.

“codeType”—Type of code in this cell. Valid code types include “SCRIPT” (e.g. interpreted code such as JavaScript), “COMPILABLE” (e.g. C source code that must be compiled into a loadable binary), and “BINARY” (a loadable binary).

“code”—Code that is specific to this cell. If the first line starts with a “file://” URL, then code read from the local file system will be prepended to any subsequent lines of source code. In the case of BINARY code, providing a link to a file is the only valid option.

Continuing at step 2112, the contents of the cell repository is read from the underlying data store. The “CellRepository” object in the code is populated with the entire multi-dimensional array data, and an array of “CellData” objects is populated with the per-cell data. When reading in the CellData, the coordinates are specified in N-dimensional space as an N-tuple. In order to store the CellData objects as an array, the N-tuple coordinates must be “flattened” into an array index. The cell array is flattened into row-major order using the following algorithm:

//The algorithm for calculating the location within a flattened n-dimensional array is a // series. Assuming that the coordinate is an n-tuple (C0, C1, . . . Cn−1), and the dimensions // are an n-tuple (D0, D1, . . . Dn−1), the equation for row-major ordering would be:

//location=(Cn−1)+(Cn−2)(Dn−1)+(Cn−3)(Dn−1)(Dn−2)+ . . . (C0)(Dn−1)(Dn−2) . . . (D1)

At step 2116, the CellRepository and CellData objects are check for the following errors:
1. Valid dimensions string for the array
2. The number of cells defined is consistent with the dimensions
3. The initialCell specifies valid coordinates
4. Valid code types are specified for common (if provided) and per-cell code
5. Every cell is defined in the array
6. Every cell contains or refers to code

At step 2120, if an error is found in the cell repository data, the user is notified and the cell flow is not started. If the cell data has been successfully validated, processing proceeds to step 2124, where a stop request is sent to the currently executing cell. At step 2128, a short wait state is entered to allow the running cell the time to complete the stop processing.

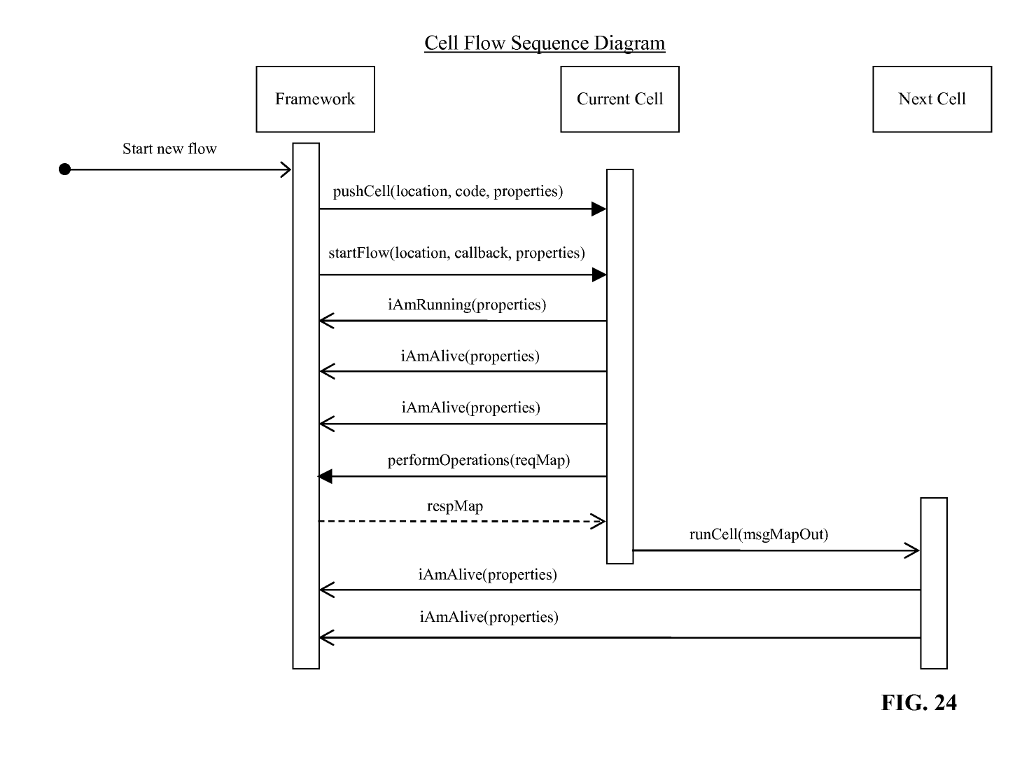

Steps 2136 and 2140 perform the actions needed to load the new cells into the executing processors, and initiate the flow at the initial cell. FIG. 24 shows an example sequence of the messages sent during the cell flow initialization and operations. In one embodiment, in which the cells are executing on the same host, the messages can be sent using standard inter-process or intra-process communication mechanisms. In an alternative embodiment, in which the cells are executing on separate hosts, a standard networking protocol, such as TCP/IP, can be utilized to send messages.

At step 2136 in FIG. 14, each cell read from the repository is pushed to the executing processors using the pushCell message. This message contains the location of the cell being pushed, as an integer index into the cellData array. The message also contains the code to be executed, which can either be source code statements, or binary code, depending on the codeType of the cell. Finally, the message contains a properties map, which allows the framework to pass a set of name/value string properties to the cell. Properties passed to the cell include, but are not limited to, the codeType, the dimensions of the array, an optional debugCode flag.

After all of the cells have been loaded, the framework sends a startFlow message to the initialCell. This message contains the location of the initialCell. In one embodiment, the message also contains a callback handle so that the executing cell can send the iAmAlive and performOperation messages to the framework. Finally, the startFlow message contains a properties map, which allows the framework to pass a set of name/value string properties to the cell. Properties passed to the cell include, but are not limited to, an optional aliveTimeCallbackPeriod value, and the buildScript commands, if the codeType is “COMPILABLE”.

FIG. 15 shows the initialization and processing sequence of an individual cell. It is necessary that each cell processor contain startup code that allows it and handle the pushCell message sent from the framework. At step 2208, the code and data sent in the pushCell message is processed. In one embodiment in which the codeType is “SCRIPT”, processing includes initializing the script engine, preprocessing the scripting code, and saving locally any variables sent in the pushCell message. In an alternative embodiment, in which the codeType is “COMPILABLE”, processing would include a compilation and build step by invoking the commands contained in the buildScript value. If the codeType is “BINARY,” then the code is loaded into the processor and executed.

After the cell has been initialized, a wait loop is entered at step 2212 to wait for a startFlow or runCell message. If at step 2216 no message has been received, the cell will continue to wait at step 2212. Otherwise, the run message will be processed at step 2220.

At step 2220, an iAmRunning message will first be sent to the framework to indicate which cell is currently running. The framework needs to know which cell is running in order to send a shutdown message and terminate the flow at an appropriate time. In the case of a startFlow message received from the framework, no additional processing is needed. In the case of a runCell message received from another cell, history data from the last cell to execute can be extracted from the message if available. The data to be extracted includes the number of consecutive performOperation successes, the number of consecutive performOperation failures, and a history of the prior cells visited. The cell history may be stored in a circular buffer structure, which limits the total number of entries to a predetermined number.

Prior to performing additional processing, the cell checks at step 2224 if a shutdown message has been received from the framework. If a shutdown message has been received, the cell performs a clean shutdown, thereby terminating the flow. If a shutdown message has not been received, the cell enters a delay state at step 2226.

At step 2226, a run loop will be executed to periodically send the isAlive messages during the sleep period. If the aliveTimeCallbackPeriod is less than the cellDelay, then the function will simply sleep for the required time and then send the performOperation message to the framework. The processing at step 2226 is described in the following pseudo code:

```
// The cellDelay variable is specified in cell code, and indicates how long
// the cell should wait before sending the performOperation message.
if (aliveTimeCallbackPeriod < cellDelay) {
  Send isAlive message
  stopTime = currentTime + cellDelay
  while (currentTime < stopTime and shutdown message not received) {
    Sleep for aliveTimeCallbackPeriod milliseconds
    Send isAlive message
  }
}
else {
  Sleep for cellDelay milliseconds
}
If (shutdown message received) {
  Terminate cell processing
}
```

After exiting the delay state at step 2226, the cell sends the performOperation message to the framework at step 2230. The performOperation message contains a request map parameter that identifies the operation that the framework should complete. In one embodiment, the operation to perform is to submit a search request to the posting service. Invoking the performOperation message results in a response being sent from the framework which contains a map of response values. One of the values returned indicates the success or failure status from performing the operation. In one embodiment, another returned value indicates the remaining battery capacity of the mobile device.

At step 2234, the logic to determine which cell to invoke next is performed. The determination of which cell to run next is implementation-specific, and one of the customization points of the invention. In one embodiment, the following set of rules is invoked:
1. Transition to the cell with the correct battery capacity, if required, by moving up or down one cell.
2. If the response code indicates success, move one column left, if possible.
3. If the response code indicates failure, move one column right if possible.

In addition to determining which cell to run next at step 2238, an output map preferably is constructed to pass to the next cell. The output map includes the number of consecutive performOperation successes, the number of consecutive performOperation failures, and a history of the prior cells visited. After the output map is constructed, the runCell message is sent to the next cell. The current cell returns to the wait state at step 2212, to wait for the arrival of another runCell message.

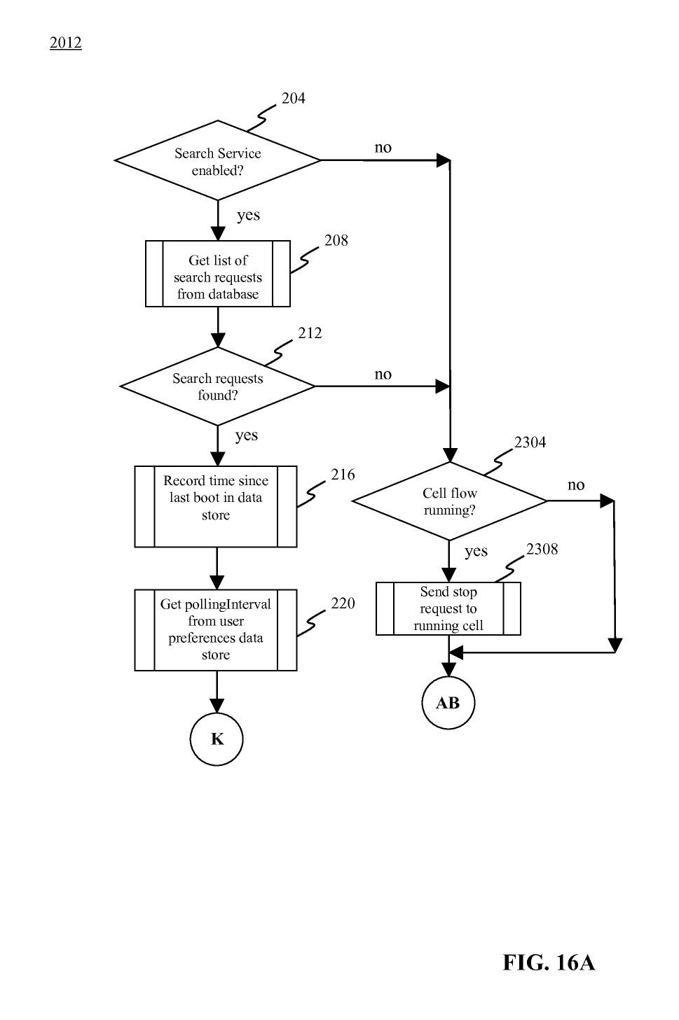

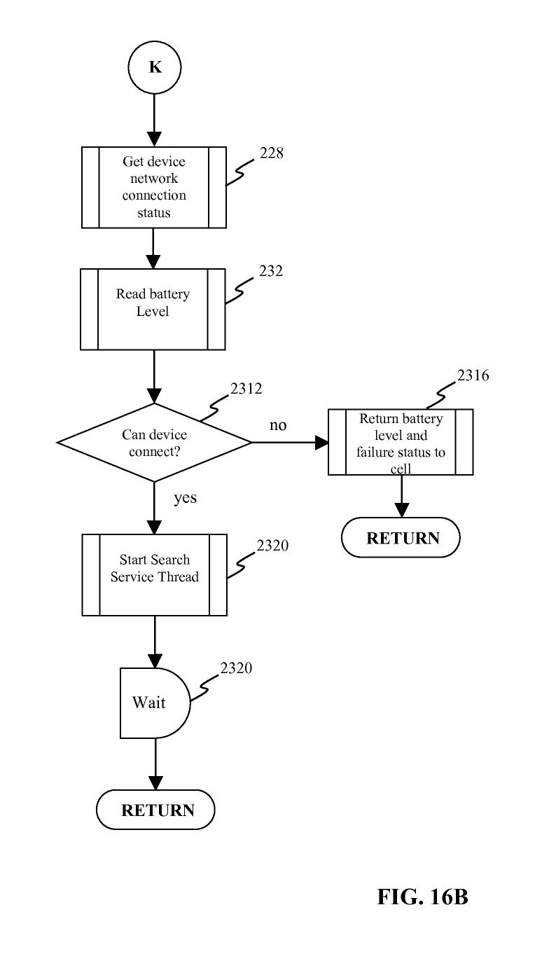

In FIGS. 16A and 16B, step 2012 is detailed. At step 204, if the search service is enabled proceed to step 208 to continue with the search. Otherwise, a determination is made at step 2304 about whether the cell flow is currently running. If the cell flow is running, a stop message is sent to the running cell to terminate the flow, after which the code returns to step 152 (FIG. 13) to await either a search request at step 2016, or additional user input at step 146. If the cell flow is not running, proceed directly to step 152 (FIG. 13).

At step 208, a list is obtained of search request objects from a data set. These are searches and associated criteria input by the user. Typically, search request objects would be stored in a relational database, but this is not required. A search request object comprises:
1. A short description of the request
2. The content reference for the request
3. Filters for the search, including:
   a. Prices ranges
   b. Age limits
   c. Square footage
   d. Number of bedrooms and bathrooms
   e. Property type (e.g. single-family home, condo, rental, etc.)
   f. Property listing categories (Open house, new listing, reduced price, foreclosure etc.)
   g. Customer type (e.g. private or commercial)
   h. Geographical regions
   i. Job type (e.g. temp, part-time, regular, volunteer, etc.)
   j. Posting language
   k. Reputation or computed safety rating of seller
   l. Personal categories (male, female, platonic, etc.)
   m. Boolean search algebra (e.g. match any, match all, etc.)
4. Search category (e.g. for sale, housing, services, etc.)
5. Auto search enabled flag (true if the search should be run in the background, false otherwise)
6. Last hit time (calendar time of the most recent match from the previous search)
7. Identifier for the last item that was successfully matched. The identifier can be a content reference or other string that is unique for the posting service.
   After completing step 208, a decision is made at step 212 whether search request objects are found. If not, a determination is made at step 2304 about whether the cell flow is currently running, as previously described. If search requests objects are found, at step 216 the process records time since last boot in a data store.

The data store can be on a file system, or some other data storage mechanism. The data can be represented a simple name-value pair association. A battery operated device can go into “Deep Sleep” mode to save battery life. The time since last boot is the absolute amount of time since the device was lasted powered on, and includes the time that the device was in Deep Sleep mode. This time can be used, in one embodiment, to determine when to schedule the service to run.

The process at step 220 obtains polling time interval, according to user preference, from the data store. The polling interval is specified by the user as the number of hours and seconds in which to periodically run the automatic searches.

The process at step 224 obtains an error count. The error count is the number of failed attempts to contact the server data feed since the last successful connection. This is used in the process retry logic at step 240.

The process determines at step 228 the ability of the device to connect to the network. The network comprises the cellular network 1110, the local area network 1120, the point-to-point network 1130.

The process at step 232 reads battery status from the device. This would typically be the percentage of maximum capacity remaining on the device.

The process at step 236 decides if the device can connect to the network. If not, the process performs the process retry logic at step 240. Also the process performs the process retry logic step 240 if the battery capacity is insufficient. Battery sufficiency can be determined by processing the charging status and the capacity remaining on the device. The result of a step 240 operation determines when to the schedule the next attempt to connect to the network and execute background search processing.

If the process at step 236 decides that the device can connect to the network, the process proceeds to reset error count at step 244. The error count is reset to a value, such as zero, which indicates that no errors are outstanding. The value is saved in a data store for the next time that the background search is executed.

The process next starts an asynchronous thread at step 248 executing the steps from step 404 to 456 (returning to step 248 at step 460) (shown in more detail in FIGS. 4A and 4B). Step 248 will execute the background search.

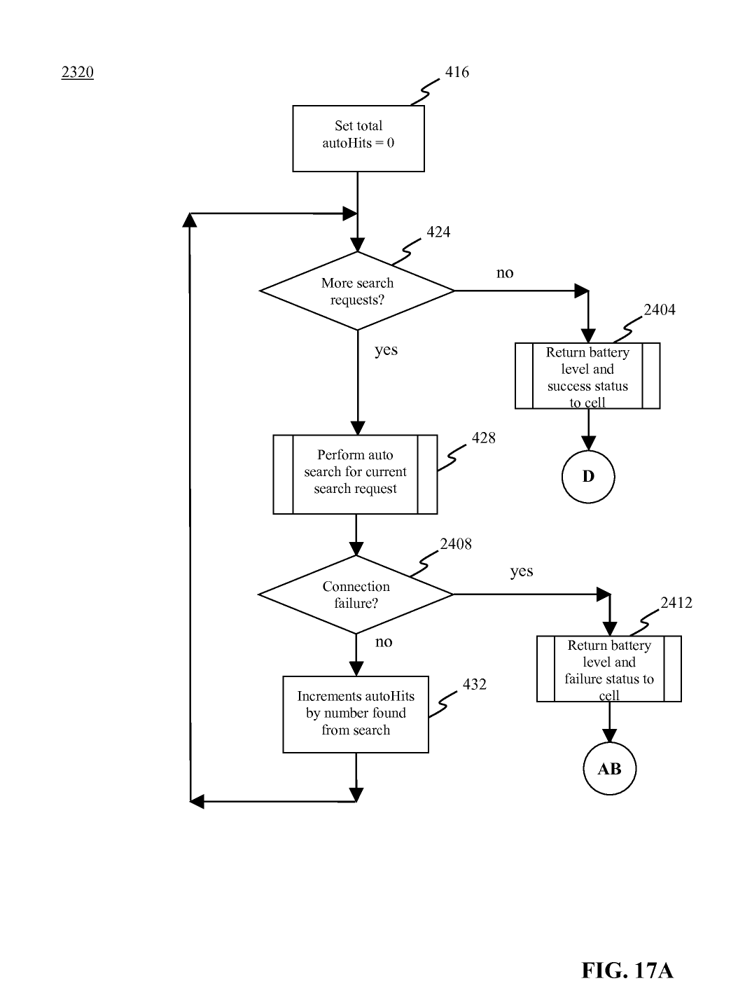

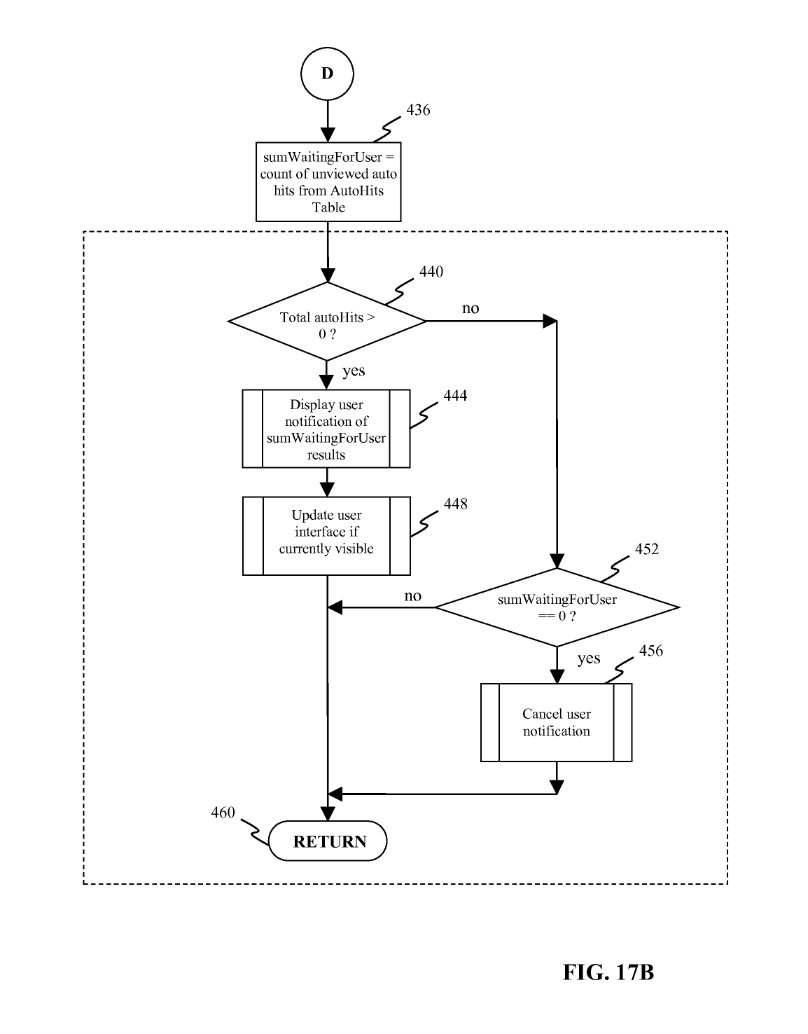

FIGS. 17A and 17B show a search thread that is an asynchronous task running in the background.

At step 416 initialize the autoHits count to zero. The autoHits count is the number of postings that are found by executing all of the search requests.

Next proceed to iterate steps 424, 428, 2408, and 432. At 424, determine if more search requests are outstanding. If not, return a successful response message to the invoking cell at step 2404 with an updated battery level, terminate looping, and proceed to step 436. Otherwise, proceed to step 428 where a search for a current search request is performed. At step 2408, if a connection failure occurred when performing the search, then return a failed response message to the invoking cell at step 2412 with an updated battery level. In the case of a connection failure, the code returns to step 152 to await either a search request at step 2016, or additional user input at step 146. If the current search was successful, then increment at step 432 the autoHits by the number found from the search. Next, the process loops back to step 424.

The search and the user interface process are asynchronous, so the user can look at an autoHits table (see FIGS. 8A, 8B, and 8C and accompanying description), while the search is in progress. Therefore at step 436, a count (sumWaitingForUser) of the current unviewed autoHits is queried from the data store. Then proceed to steps 440 to 456 where the user is notified of search results. The user can be notified during background search or when the app is running in the foreground. This can be accomplished by adding a notification selector in the mobile status area, or displaying a notification widget on the user's home screen.

At step 440, a check is made to determine if the number of autoHits from the previous search iteration (steps 424, 428, and 432) is greater than zero. If the number is not greater than zero, proceed to step 452. At step 452, determine if the sumWaitingForUser is equal to zero. If the sumWaitingForUser is equal to zero, cancel at step 456 any user notification currently displayed. This can be accomplished by removing the notification selector in a status area, or by removing a notification widget in the user's home screen. Next, return to the caller at step 460. If, at step 452, the sumWaitingForUser is not equal to zero, return to the caller at step 460 without canceling the user notification.

If, at step 440, the number of autoHits is greater than zero, the process proceeds to step 444 where a user notification of sumWaitingForUser results is displayed. Then at the next step, step 448, a user interface is updated if currently visible. After step 448, at step 460, the process returns to the caller.

### REFERENCE TO COMPUTER PROGRAM LISTING APPENDICES

Computer program listing appendix, corresponding to the program listings discussed below, is filed herewith, in accordance with 37 C.F.R. 1.52(e). This computer program listing appendix is incorporated herein by reference in its entirety, in accordance with 37 C.F.R. 1.77(b)(4). The appendix includes subfiles which are identified as follows:

### Name

BatteryFlowManager.java

### CellCode1.js

### CellCode2.js

CellComputable.java
CellData.java
CellRepository.java
CellRepository1.json
CellRepository2.json
CellRepository3.json
CellRepository4.json
CellRepository5.json
CellRepositoryFactory.java

### CommonCodel.js

FileUtils.java
FlowException.java
FlowManager.java
FlowManagerFactory.java
FlowProperties.java
InvalidCoordinateException.java
Iso8601DateParser.java
JavaScriptFlowManager.java
JsonCellRepository.java
RepositoryFormatException.java
RepositoryTest.java
StringUtils.java

In addition, a copy of a compact disc created on Nov. 22, 2010 was submitted as an appendix to U.S. Provisional application No. 61/458,442 filed Nov. 23, 2010 by Larry Deutsch. An electronic copy of files on the compact disk is also filed herewith, which application and appendix are incorporated by reference in their entirety.

The files previously submitted on the compact disk were identified as follows:

| File Name | Size | Date |
|---|---|---|
| Address.java | 3,439 | Nov. 22, 2010 |
| AppPreferenceActivity.java | 5,219 | Nov. 22, 2010 |
| AutoHit.java | 6,500 | Nov. 22, 2010 |
| BoundedLruCache.java | 2,274 | Nov. 22, 2010 |
| Categories.java | 9,255 | Nov. 22, 2010 |
| CheckBoxPreferenceWithLongSummary.java | 1,557 | Nov. 22, 2010 |
| clear_data_dialog.xml | 2,182 | Nov. 22, 2010 |
| ClearDataPreference.java | 10,621 | Nov. 22, 2010 |
| colors.xml | 651 | Oct. 30, 2010 |
| Constants.java | 6,415 | Nov. 22, 2010 |
| Contact.java | 3,147 | Nov. 22, 2010 |
| ContactAPI.java | 2,095 | Nov. 22, 2010 |
| ContactAPI3.java | 7,048 | Nov. 22, 2010 |
| ContactAPI5.java | 8,878 | Nov. 22, 2010 |
| ContactList.java | 1,218 | Nov. 22, 2010 |
| CraigslistHtmlParser.java | 11,371 | Nov. 22, 2010 |
| CraigslistUrl.java | 5,889 | Nov. 22, 2010 |
| custom_dialog.xml | 2,267 | Nov. 22, 2010 |
| CustomAlertDialog.java | 5,081 | Nov. 22, 2010 |
| Database.java | 25,798 | Nov. 22, 2010 |
| Email.java | 1,962 | Nov. 22, 2010 |
| FinditAlertService.java | 8,645 | Nov. 22, 2010 |
| FinditApplication.java | 6,479 | Nov. 22, 2010 |
| FinditServiceConnection.java | 3,340 | Nov. 22, 2010 |
| FinditServiceReceiver.java | 1,375 | Nov. 22, 2010 |
| HtmlParsingResults.java | 1,573 | Nov. 22, 2010 |
| ImageDownloader.java | 22,606 | Nov. 22, 2010 |
| ImageUrl.java | 1,430 | Nov. 22, 2010 |
| Iso8601DateParser.java | 2,433 | Nov. 22, 2010 |
| item_web_view.xml | 1,029 | Nov. 22, 2010 |
| LineReader.java | 3,818 | Nov. 22, 2010 |
| list_item_icon_text.xml | 1,319 | Nov. 22, 2010 |
| list_item_text.xml | 1,103 | Nov. 22, 2010 |
| location.xml | 2,586 | Nov. 22, 2010 |
| LocationActivity.java | 25,128 | Nov. 22, 2010 |
| LocationRecord.java | 5,768 | Nov. 22, 2010 |
| Locations.java | 22,742 | Nov. 22, 2010 |
| map_result_dialog.xml | 3,176 | Nov. 22, 2010 |
| number_picker.xml | 1,634 | Oct. 17, 2010 |
| NumberPicker.java | 14,049 | Nov. 22, 2010 |
| NumberPickerButton.java | 2,527 | Sep. 19, 2010 |
| Phone.java | 1,888 | Nov. 22, 2010 |
| Range.java | 2,107 | Nov. 22, 2010 |
| RdfItem.java | 7,328 | Nov. 22, 2010 |
| RdfParser.java | 26,178 | Nov. 22, 2010 |
| review_list.xml | 1,285 | Nov. 22, 2010 |
| ReviewSearchResults.java | 47,293 | Nov. 22, 2010 |
| save_result_dialog.xml | 5,499 | Nov. 22, 2010 |
| save_search_dialog.xml | 3,896 | Nov. 22, 2010 |
| saved_overview.xml | 6,162 | Nov. 22, 2010 |
| SavedActivity.java | 54,731 | Nov. 22, 2010 |
| search_criteria.xml | 2,887 | Nov. 22, 2010 |
| SearchCriteria.java | 26,016 | Nov. 22, 2010 |
| SearchItemAdapter.java | 6,302 | Nov. 22, 2010 |
| SearchRequest.java | 8,134 | Nov. 22, 2010 |
| SearchResult.java | 5,908 | Nov. 22, 2010 |
| SearchTabActivity.java | 2,507 | Nov. 22, 2010 |
| sendto.xml | 4,325 | Nov. 22, 2010 |
| ServiceCallable.java | 1,164 | Nov. 22, 2010 |
| ServiceTimerTask.java | 13,675 | Nov. 22, 2010 |
| spinner_view.xml | 888 | Nov. 22, 2010 |
| spinner_view_dropdown.xml | 891 | Nov. 22, 2010 |
| strings.xml | 16,669 | Nov. 22, 2010 |
| StyleableSpannableStringBuilder.java | 1,789 | Nov. 22, 2010 |
| styles.xml | 1,517 | Nov. 18, 2010 |
| TimePickerPreference.java | 11,691 | Nov. 22, 2010 |
| ToggleButtonGroupTableLayout.java | 2,767 | Nov. 22, 2010 |
| UrlParam.java | 1,594 | Nov. 22, 2010 |
| Utils.java | 26,315 | Nov. 22, 2010 |
| ViewItem.java | 18,256 | Nov. 22, 2010 |

I claim:

1. A digital processing apparatus to manage a covariant relationship of battery usage characteristics of a device with responsiveness of an application comprising:
an operating system;
a control logic, in communication with the operating system, comprising an array of cells of at least two dimensions and a framework wherein:
each cell determines which of one or more framework operations to perform and when to perform the one or more framework operations and wherein:
the cell invokes one or more framework operations;
the cell chooses which subsequent cell to perform in a cell flow;
the cell formats output and invokes the processing of the subsequent cell;
and wherein:
the framework determines how to perform the one or more operations wherein:
the framework stops the execution of a prior cell flow, and
the framework starts the execution of a current cell flow.

2. A method for managing a covariant relationship of battery usage characteristics of a device with responsiveness of an application comprising:
invoking an operating system;
invoking a control logic, in communication with the operating system, comprising an array of cells of at least two dimensions and a framework wherein cell steps comprise:
determining which of one or more framework operations to perform and when to perform the one or more framework operations wherein cell steps further comprise:
invoking one or more framework operations,
choosing which subsequent cell to perform in a cell flow,
formatting output and invoking the processing of the subsequent cell, and wherein the framework steps comprise:
determining how to perform the one or more operations wherein the framework steps further comprise:
stopping the execution of a prior cell flow, and
starting the execution of a current cell flow.

3. The apparatus of claim 1 further comprising:
one or more cell repositories comprising coordinates of an initial cell; and
the one or more cell repositories comprising the dimensions of the array of cells;
wherein the cell repository is accessed by the framework.

4. The apparatus of claim 3 further comprising:
the one or more cell repositories comprising at least one data element wherein the least one data element is selected from one or more members of the group consisting of: a heartbeat time interval, a one dimensional array of common code types and a one dimensional array of common codes, and one or more build scripts each comprising a set of operating system commands.

5. The apparatus of claim 3 wherein the one or more cell repositories comprise a battery usage profile selectable at run time.

6. The apparatus of claim 4 wherein the elements of the array of common code types are selected from the group consisting of interpreted code, compilable code, and binary code.

7. The apparatus of claim 1 wherein each element of the array of cells is executed by one or more separate processors.

8. The method of claim 2 further comprising:
one or more cell repositories comprising coordinates of an initial cell; and
the one or more cell repositories comprising the dimensions of the array of cells;
wherein the cell repository is accessed by the framework.

9. The method of claim 8 further comprising:
the one or more cell repositories comprising at least one data element selected from one or more members of the group consisting of: a heartbeat time interval, a one dimensional array of common code types and a one dimensional array of common codes, and one or more build scripts each comprising a set of operating system commands.

10. The method of claim 8 wherein the one or more cell repositories comprise a battery usage profile selectable at run time.

11. The method of claim 2 wherein elements of the array of cells are executed by one or more separate processors.

12. The method of claim 2 wherein elements of the array of cells are executed by one or more separate processors.

13. The method of claim 2 wherein cell steps further comprise:
running cell initialization;
waiting for a run message to be received;
upon receiving a run message, sending a iAmRunning message and extracting data from the run message;
upon receiving a shutdown message stopping processing of current cell else continue:
executing a delay loop;
invoking a framework operation;
calculating the next cell;
formatting output;
running the next cell; and
returning to the waiting step.

14. The method of claim 13 wherein the run message comprises a start flow message.

15. The method of claim 13 wherein the run message comprises a run next cell message.

16. The apparatus of claim 1 wherein the cells further comprise:
a cell initialization;
a wait state;
upon receiving a run message, a send iAmRunning message and a extract data from the run message;
upon receiving a shutdown message entering a stop processing state else:
an invoke framework operation;
a calculate next cell operation;
a format output and run next cell operation;
and a return to wait state.

17. A digital processing apparatus to manage a covariant relationship of battery usage characteristics of a device with responsiveness of an application comprising:
an operating system;
a control logic, in communication with the operating system, comprising an array of cells of at least two dimensions wherein each cell comprises:
a delay loop;
an invoke framework operation;
a determine next cell calculation logic;
and a format output.

18. The apparatus of claim 17 wherein the invoke framework operation comprises:
a perform operations message to be sent to a framework, wherein the operations message comprises a request map parameter that identifies the operations that the framework should complete.

19. The apparatus of claim 17 wherein the determine next cell calculation logic comprises:
if a received response value is a battery performance indicator, then transition to a vector within the array with one or more matching indicators;
if the response value indicates success, calculation of an adjacent cell to the left in the vector;
if the response value indicates failure, calculation of an adjacent cell to the right in the vector.

20. The apparatus of claim 19 wherein the battery performance indicator is one or more indicators selected from the group consisting of battery capacity, battery temperature, number of battery charge/discharge cycles, and downlink signal strength.

21. The apparatus of claim 17 wherein the format output comprises an output map that includes a number of consecutive performOperation successes and a number of consecutive performOperation failures.

22. A method for managing a covariant relationship of battery usage characteristics of a device with responsiveness of an application comprising:
invoking an operating system;
invoking a control logic, in communication with the operating system, comprising an array of cells of at least two dimensions wherein cell steps comprise:
executing a delay loop;
invoking framework operation;
calculating next cell to invoke; and
formatting output.

23. The method of claim 22 wherein the invoke framework operation comprises:
sending a perform operations message to a framework, wherein the operations message comprises a request map parameter that identifies the operations that the framework should complete.

24. The method of claim 22 wherein the determine next cell calculation logic comprises:
if a received response value is a battery performance indicator, then transitioning to a vector within the array with one or more matching indicators;
if the response value indicates success, calculating an adjacent cell to the left in the vector;
if the response value indicates failure, calculating an adjacent cell to the right in the vector.

25. The method of claim 24 wherein the battery performance indicator is one or more indicators selected from the group consisting of battery capacity, battery temperature, number of battery charge/discharge cycles, and downlink signal strength.

26. The method of claim 22 wherein the format output comprises an output map that includes a number of consecutive performOperation successes and a number of consecutive performOperation failures.
